(19) United States
(12) Patent Application Publication
(10) Pub. No.: US 2026/0186508 A1
(43) Pub. Date: Jul. 2, 2026

(54) AUTONOMOUS VEHICLE TRANSPORTATION HUB OR ENVIRONMENTAL MONITORING

(71) Applicant: Aurora Operations, Inc., Pittsburgh, PA (US)

(72) Inventors: Christopher Paul Urmson, Los Altos, CA (US); Sterling J. Anderson, Sunnyvale, CA (US); James Andrew Bagnell, Pittsburgh, PA (US); Jason Leu, Pittsburgh, PA (US); Colin Mease, Pittsburgh, PA (US)

(21) Appl. No.: 19/003,549

(22) Filed: Dec. 27, 2024

Related U.S. Application Data
(60) Provisional application No. 63/738,981, filed on Dec. 26, 2024.

(51) Int. Cl. G05D 1/69; G05D 1/246; G05D 1/667; G05D 101/15; G05D 105/28; G05D 107/70; G05D 109/10; G05D 111/10; G05D 111/30

(52) U.S. Cl. CPC G05D 1/69; G05D 1/246; G05D 1/667; G05D 2101/15; G05D 2105/28; G05D 2107/70; G05D 2109/10; G05D 2111/17; G05D 2111/32

(57) ABSTRACT

Perception data is captured by an autonomous vehicle during the operation of the autonomous vehicle proximate a transportation hub, and in some instances, is used to determine status information about a transportation hub such as storage location (e.g., parking space) availability, the locations and/or identities of various freight carriers within a transportation hub, and other activities occurring within a transportation hub, e.g., queues of vehicles, incidents, etc. In other instances, the perception data may be shared with another autonomous vehicle to supplement the perception data collected by the other autonomous vehicle and improve the field of view of the other autonomous vehicle when operating within a transportation hub, e.g., when the other autonomous vehicle is towing a freight carrier that partially blocks the field of view of the other autonomous vehicle.

### BACKGROUND

As computing and vehicular technologies continue to evolve, autonomy-related features have become more powerful and widely available, and capable of controlling vehicles in a wider variety of circumstances. For automobiles, for example, the automotive industry has generally adopted SAE International standard J3016, which designates 6 levels of autonomy. A vehicle with no autonomy is designated as Level 0, and with Level 1 autonomy, a vehicle controls steering or speed (but not both), leaving the operator to perform most vehicle functions. With Level 2 autonomy, a vehicle is capable of controlling steering, speed and braking in limited circumstances (e.g., while traveling along a highway), but the operator is still required to remain alert and be ready to take over operation at any instant, as well as to handle any maneuvers such as changing lanes or turning. Starting with Level 3 autonomy, a vehicle can manage most operating variables, including monitoring the surrounding environment, but an operator is still required to remain alert and take over whenever a scenario the vehicle is unable to handle is encountered. Level 4 autonomy provides an ability to operate without operator input, but only in specific conditions such as only certain types of roads (e.g., highways) or only certain geographical areas (e.g., specific cities for which adequate map data exists). Finally, Level 5 autonomy represents a level of autonomy where a vehicle is capable of operating free of operator control under any circumstances where a human operator could also operate.

The fundamental challenges of any autonomy-related technology relate to collecting and interpreting information about a vehicle's surrounding environment, along with making and implementing decisions to appropriately control the vehicle given the current and future environment within which the vehicle is and will be operating. Therefore, continuing efforts are being made to improve each of these aspects, and by doing so, autonomous vehicles increasingly are able to reliably handle a wider variety of situations and accommodate both expected and unexpected conditions within an environment.

One particular area where environmental conditions can present different challenges to an autonomous vehicle is a transportation hub, and specifically a transportation hub that is used in connection with the transportation of freight at least partially using road-based vehicles. Transportation hubs are often decentralized and involve the interaction of numerous vehicles and parties, and in some instances, interaction in confined areas without clearly defined roads or paths.

As such, a need exists in the art for improved manners of facilitating the operation of autonomous vehicles in transportation hubs as well as other challenging environments.

### SUMMARY

The present disclosure is related to various uses of perception data captured by an autonomous vehicle during the operation of the autonomous vehicle proximate to a transportation hub and/or in other environments. In some instances, the perception data may be used to determine status information about a transportation hub such as storage location (e.g., parking space) availability, the locations and/or identities of various freight carriers within a transportation hub, and other activities occurring within a transportation hub, e.g., queues of vehicles, incidents, etc. In other instances, the perception data may be shared with another autonomous vehicle to supplement the perception data collected by the other autonomous vehicle and improve the field of view of the other autonomous vehicle when operating within a transportation hub, e.g., when the other autonomous vehicle is towing a freight carrier that partially blocks the field of view of the other autonomous vehicle.

Therefore, consistent with some implementations, a method implemented by one or more processors may include receiving perception data captured by one or more perception sensors of an autonomous vehicle during operation of the autonomous vehicle proximate a transportation hub, identifying one or more entities disposed within the transportation hub using the perception data, and determining status information for the transportation hub using the one or more entities identified using the perception data.

In some implementations, identifying the one or more entities and determining the status information are performed by an autonomous vehicle control system resident in the autonomous vehicle. Also, in some implementations, at least one of identifying the one or more entities and determining the status information are performed by a remote service in communication with an autonomous vehicle control system of the autonomous vehicle.

Further, in some implementations, the perception data is captured by the one or more sensors while the autonomous vehicle is disposed within the transportation hub. In some implementations, the perception data is captured by the one or more sensors while the autonomous vehicle is driving by the transportation hub. In addition, in some implementations, the autonomous vehicle is an autonomous truck configured to transport one or more freight carriers.

Some implementations may also include, in an autonomous vehicle control system of the autonomous vehicle, controlling movement of the autonomous vehicle using the determined status information. In addition, some implementations may also include, in an autonomous vehicle control system of a second autonomous vehicle, controlling movement of the second autonomous vehicle using the determined status information. Moreover, in some implementations, identifying the one or more entities disposed within the transportation hub using the perception data includes processing the perception data with a trained machine learning model disposed in a perception system of the autonomous vehicle. In some implementations, the trained machine learning model is a multi-head machine learning model including a plurality of output heads, the plurality of output heads including at least one entity identification output head that outputs the one or more entities disposed within the transportation hub and at least one mainline perception output head that outputs a plurality of objects detected in a vicinity of the autonomous vehicle.

Moreover, in some implementations, each of the one or more perception sensors includes an image sensor, a LIDAR sensor, or a RADAR sensor. Some implementations may also include, in an autonomous vehicle control system of the autonomous vehicle or a different autonomous vehicle, controlling movement of the autonomous vehicle or the different autonomous vehicle to park the autonomous vehicle or the different autonomous vehicle in the available storage location or to drop off a freight carrier in an available storage location identified in the status information. In addition, some implementations may also include, in an autonomous vehicle control system of the autonomous vehicle or a different autonomous vehicle, controlling movement of the autonomous vehicle or the different autonomous vehicle for pickup of a freight carrier based upon a location of the freight carrier identified in the determined status information.

In some implementations, the transportation hub is a trucking drop yard, a container port, an intermodal freight facility, or a loading dock. Moreover, in some implementations, identifying the one or more entities includes identifying a freight carrier stored in the transportation hub, and determining the status information includes determining an identification and/or location of the freight carrier in the transportation hub. Also, in some implementations, identifying the one or more entities includes identifying a vehicle parked in the transportation hub, and determining the status information includes determining an identification and/or location of the vehicle in the transportation hub.

In some implementations, determining the status information includes identifying one or more available storage locations in the transportation hub. In addition, in some implementations, identifying the one or more entities includes identifying a plurality of vehicles and/or freight carriers in the transportation hub, and the method further includes mapping the identified plurality of vehicles and/or freight carriers to predetermined storage locations in a map of the transportation hub, and identifying the one or more available storage locations in the transportation hub includes identifying the one or more available storage locations using the mapping of the identified plurality of vehicles and/or freight carriers to the predetermined storage locations in the map of the transportation hub.

Also, in some implementations, identifying the one or more entities includes identifying a plurality of vehicles queued to perform a predetermined activity in the transportation hub, and determining the status information includes determining a number of vehicles waiting to perform the predetermined activity and/or estimated wait to perform the predetermined activity using the identified plurality of vehicles. Moreover, in some implementations, identifying the one or more entities includes identifying first and second entities in the transportation hub, and determining the status information includes determining an incident between the first and second entities. Further, in some implementations, each of the first and second entities is a vehicle, a freight carrier, a stationary object in the transportation hub, or an individual. Also, in some implementations, identifying the one or more entities includes identifying one or more individuals in the transportation hub, and determining the status information includes determining a status or activity of the one or more individuals.

Further, in some implementations, the status information is first status information, the perception data is first perception data, and the autonomous vehicle is a first autonomous vehicle, the method further including receiving second status information for the transportation hub, the second status information determined using a plurality of entities identified using perception data captured by perception sensors of a plurality of autonomous vehicles during operation of the plurality of autonomous vehicles proximate the transportation hub.

Some implementations may further include receiving second perception data captured by one or more perception sensors of a second autonomous vehicle of the plurality of autonomous vehicles during operation of the second autonomous vehicle proximate the transportation hub, and identifying one or more entities disposed within the transportation hub using the second perception data, and at least a portion of the second status information is determined using the one or more entities identified using the second perception data.

Some implementations may also include initiating updating of a live status map of the transportation hub using the status information. In addition, some implementations may further include sharing at least a portion of the live status map of the transportation hub with one or more autonomous vehicles in a fleet, with a shipper, with a carrier, and/or with a governmental authority. Some implementations may also include generating a summary report using at least a portion of the live status map of the transportation hub, and sharing the summary report with one or more autonomous vehicles in a fleet, with a shipper, with a carrier, and/or with a governmental authority. Some implementations may further include, in response to a query issued to an API, generating a response including at least a portion of the live status map.

Consistent with some implementations, a method implemented by one or more processors may include receiving status information for a transportation hub, the status information determined using a plurality of entities identified using perception data captured by perception sensors of a plurality of autonomous vehicles during operation of the plurality of autonomous vehicles proximate the transportation hub, initiating updating of a live status map of the transportation hub using the received status information, and in response to each of a plurality of queries, sharing at least a portion of the live status map with one or more requesters.

Consistent with some implementations, a method implemented by one or more processors may include receiving perception data captured by one or more perception sensors of an autonomous vehicle during operation of the autonomous vehicle in an environment, identifying one or more available parking spaces disposed within the environment using the perception data, and initiating updating of a live parking availability map using the one or more available parking spaces identified using the perception data.

In some implementations, identifying the one or more entities is performed by an autonomous vehicle control system resident in the autonomous vehicle and initiating updating of the live parking availability map is performed by a remote service in communication with the autonomous vehicle control system, the method further including communicating the one or more available parking spaces identified using the perception data from the autonomous vehicle control system to the remote service. Further, in some implementations, identifying the one or more entities is performed by a remote service in communication with an autonomous vehicle control system of the autonomous vehicle. Also, in some implementations, the autonomous vehicle is an autonomous truck configured to transport one or more freight carriers.

In addition, some implementations may also include, in an autonomous vehicle control system of the autonomous vehicle, controlling movement of the autonomous vehicle using availability data received from the live parking availability map. In some implementations, the autonomous vehicle is a first autonomous vehicle, and the method further includes, in an autonomous vehicle control system of a second autonomous vehicle, controlling movement of the second autonomous vehicle using availability data received from the live parking availability map. In addition, in some implementations, controlling movement of the second autonomous vehicle includes autonomously parking the autonomous vehicle in a parking space identified as available in the availability data.

Also, in some implementations, the availability data identifies a plurality of available parking spaces, and the method further includes identifying the parking space identified as available in the availability data as a closest or most convenient available parking space among the plurality of available parking spaces.

In addition, in some implementations, the perception data is first perception data, the one or more available parking spaces identified using the first perception data are from a first set of available parking spaces, and the autonomous vehicle is a first autonomous vehicle, and the method further includes initiating updating of the live parking availability map using a second set of available parking spaces identified using perception data captured by one or more perception sensors of a second autonomous vehicle during operation of the second autonomous vehicle in the environment.

In addition, some implementations may also include identifying a plurality of vehicles in the environment using the perception data, and mapping the identified plurality of vehicles to predetermined parking spaces in a map of the environment, and identifying the one or more available parking spaces disposed within the environment includes identifying the one or more available parking spaces using the mapping of the identified plurality of vehicles to the predetermined parking spaces in the map of the environment.

Some implementations may also include sharing at least a portion of the live parking availability map with one or more autonomous vehicles in a fleet and/or with a governmental authority. Some implementations may further include in response to each of a plurality of queries, sharing availability data from the live parking availability map with one or more requesters.

In addition, some implementations may also include, in response to a query issued to an API, generating a response including availability data from the live parking availability map. Some implementations may further include generating a map overlay including availability data from the live parking availability map, and generating a graphical map display of a geographic area using the map overlay.

Consistent with some implementations, a method implemented by one or more processors may include receiving perception data captured by one or more perception sensors of an autonomous vehicle during operation of the autonomous vehicle in an environment, identifying one or more environmental hazards disposed within the environment using the perception data, and notifying a third party of the identified one or more environmental hazards identified using the perception data.

Moreover, in some implementations, identifying the one or more environmental hazards includes identifying one or more of a stranded vehicle, litter accumulation, a pothole, vegetation growth along a roadway, or an object in a roadway. Further, in some implementations, notifying the third party of the identified one or more environmental hazards identified using the perception data includes notifying a governmental authority of the identified one or more environmental hazards identified using the perception data.

Consistent with some implementations, a method implemented by one or more processors may include receiving perception data captured by one or more perception sensors of an autonomous vehicle during operation of the autonomous vehicle proximate a queue of vehicles in an environment, identifying a plurality of vehicles in the queue of vehicles, determining a number of the plurality of vehicles and/or an estimated wait time in the queue of vehicles using the identified plurality of vehicles, and generating a notification of the determined number of the plurality of vehicles and/or the estimated wait time in the queue of vehicles.

In some implementations, the queue of vehicles is disposed in a transportation hub. Moreover, in some implementations, the perception data is captured by the one or more sensors while the autonomous vehicle is disposed within the transportation hub. Further, in some implementations, the perception data is captured by the one or more sensors while the autonomous vehicle is driving by the transportation hub. In addition, in some implementations, the queue of vehicles is disposed in a weigh station or a border station. In addition, some implementations may also include determining identities of at least a subset of the plurality of vehicles in the queue of vehicles using the received perception data. Also, in some implementations, determining the identities includes determining a unique alphanumeric identifier for a first vehicle among the subset of the plurality of vehicles using the received perception data. Moreover, in some implementations, determining the identities includes determining one or more of a pattern, color, shape, model, or type for a first vehicle among the subset of the plurality of vehicles using the received perception data.

In addition, some implementations may further include tracking a progress of at least one of the plurality of vehicles using perception data collected from a plurality of autonomous vehicles passing by the transportation hub at different times, and estimating the wait time based on the tracked progress.

Consistent with some implementations, a method implemented by one or more processors may include, in an autonomous vehicle control system of a first autonomous vehicle, receiving first perception data captured by one or more perception sensors of the first autonomous vehicle during operation of the first autonomous vehicle while towing a freight carrier in a transportation hub, receiving second perception data captured by one or more perception sensors of a second autonomous vehicle parked in a vicinity of the first autonomous vehicle in the transportation hub, at least a portion of the second perception data covering a blind spot of the first autonomous vehicle, and controlling movement of the first autonomous vehicle within the transportation hub using the first and second perception data.

In some implementations, the first and second perception data each include image sensor data, LIDAR sensor data and/or RADAR sensor data. Further, in some implementations, the portion of the second perception data covering the blind spot of the first autonomous vehicle covers an area behind the freight carrier towed by the first autonomous vehicle. Also, in some implementations, the portion of the second perception data covering the blind spot of the first autonomous vehicle covers an occlusion proximate to the first autonomous vehicle. Further, in some implementations, the portion of the second perception data covering the blind spot of the first autonomous vehicle covers an area around a corner proximate to the first autonomous vehicle.

Also, in some implementations, controlling movement of the first autonomous vehicle within the transportation hub using the first and second perception data includes backing up the first autonomous vehicle. In addition, in some implementations, controlling movement of the first autonomous vehicle within the transportation hub using the first and second perception data includes navigating the first autonomous vehicle past an occluded area in the transportation hub. Moreover, in some implementations, controlling movement of the first autonomous vehicle within the transportation hub using the first and second perception data includes navigating the first autonomous vehicle around a corner in the transportation hub.

Some implementations may also include receiving third perception data captured by one or more perception sensors disposed at a stationary location in the transportation hub, and controlling movement of the first autonomous vehicle within the transportation hub further uses the third perception data. Some implementations may further include receiving third perception data captured by one or more perception sensors of a third autonomous vehicle operating in a vicinity of the first autonomous vehicle in the transportation hub, and controlling movement of the first autonomous vehicle within the transportation hub further uses the third perception data. In some implementations, the second perception data is captured by the one or more perception sensors of the second autonomous vehicle while the second autonomous vehicle is in an idle mode.

Some implementations may also include an autonomous vehicle and/or a system that is remotely located from an autonomous vehicle and includes one or more processors that are configured to perform various of the operations described above. Some implementations may also include an autonomous vehicle control system including one or more processors, a computer readable storage medium such as a memory, and computer instructions resident in the computer readable storage medium or memory and executable by the one or more processors to perform various of the methods described above. Still other implementations may include a non-transitory computer readable storage medium that stores computer instructions executable by one or more processors to perform various of the methods described above. Yet other implementations may include a method of operating any of the autonomous vehicles or autonomous vehicle control systems described above.

It should be appreciated that all combinations of the foregoing concepts and additional concepts described in greater detail herein are contemplated as being part of the subject matter disclosed herein. For example, all combinations of claimed subject matter appearing at the end of this disclosure are contemplated as being part of the subject matter disclosed herein.

### BRIEF DESCRIPTION OF THE DRAWINGS

FIG. 1 illustrates an example hardware and software environment for an autonomous vehicle.

FIG. 2 is a block diagram illustrating an environmental monitoring system for an autonomous vehicle consistent with some implementations.

FIG. 3 is a block diagram illustrating a training system for training the multi-head machine learning model of FIG. 2.

FIG. 4 is a block diagram illustrating an example implementation of a live status map service consistent with some implementations.

FIG. 5 illustrates an example transportation hub capable of being encountered by an autonomous vehicle.

FIG. 6 illustrates various identifiable entities in the example transportation hub of FIG. 5.

FIG. 7 is a flowchart illustrating an example operational sequence for determining status information for a transportation hub consistent with some implementations.

FIG. 8 is a flowchart illustrating another example operational sequence for determining status information for a transportation hub consistent with some implementations.

FIG. 9 is a flowchart illustrating an example operational sequence for updating a live status map consistent with some implementations.

FIGS. 10A-10B illustrate an example container port capable of being encountered by autonomous vehicles in some implementations.

FIG. 11 illustrates an example loading dock capable of being encountered by an autonomous vehicle in some implementations.

FIG. 12 illustrates an example distribution center capable of being encountered by an autonomous vehicle in some implementations.

FIG. 13 is a flowchart illustrating an example operational sequence for updating and using a live queue status map consistent with some implementations.

FIG. 14 illustrates an example environment capable of being encountered by an autonomous vehicle in some implementations.

FIG. 15 is a flowchart illustrating an example operational sequence for determining parking space availability consistent with some implementations.

FIG. 16 is a flowchart illustrating an example operational sequence for operating an autonomous vehicle based on parking space availability consistent with some implementations.

FIG. 17 is a flowchart illustrating an example operational sequence for updating and using a live status map consistent with some implementations.

FIG. 18 is a block diagram illustrating an autonomous vehicle incorporating a distributed perception system consistent with some implementations.

### DETAILED DESCRIPTION

The various implementations discussed hereinafter are generally directed in part to the use of perception data collected by the sensors of an autonomous vehicle during the operation of the autonomous vehicle proximate a transportation hub and/or in other environments, for determining status information about the transportation hub and/or other environments and/or for implementing a distributed perception system to assist an autonomous vehicle when operating in a transportation hub. Prior to a discussion of these implementations, however, an example hardware and software environment within which the various techniques disclosed herein may be implemented will be discussed.

### Hardware and Software Environment

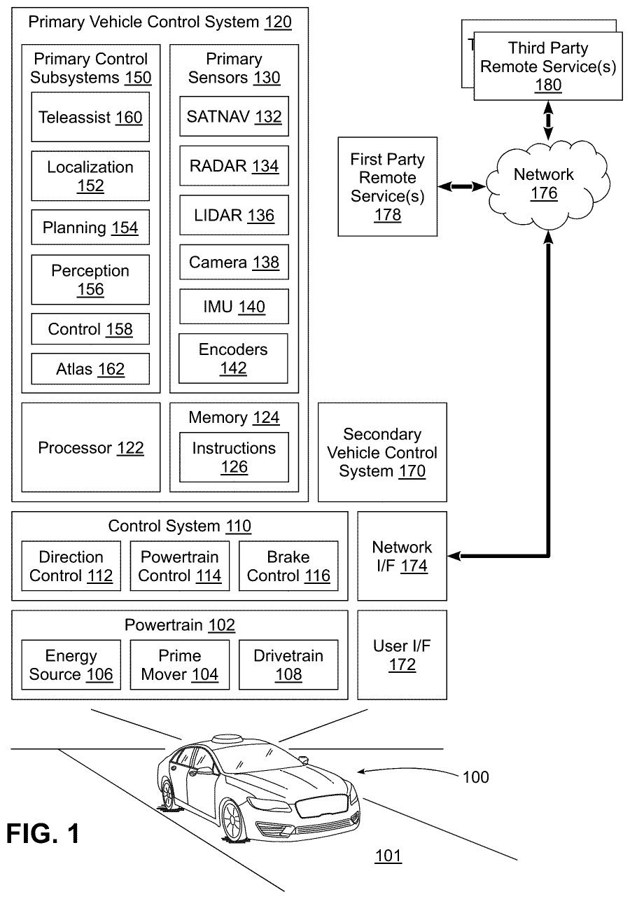

Turning to the Drawings, wherein like numbers denote like parts throughout the several views, FIG. 1 illustrates an example autonomous vehicle 100 within which the various techniques disclosed herein may be implemented. Vehicle 100, for example, is shown driving on a road 101, and vehicle 100 may include a powertrain 102 including a prime mover 104 powered by an energy source 106 and capable of providing power to a drivetrain 108, as well as a control system 110 including a direction control 112, a powertrain control 114 and brake control 116. Vehicle 100 may be implemented as any number of different types of vehicles, including vehicles capable of transporting people and/or cargo, and capable of traveling by land, by sea, by air, underground, undersea and/or in space, and it will be appreciated that the aforementioned components 102-116 can vary widely based upon the type of vehicle within which these components are utilized. In addition, vehicle 100 may be considered to be an “ego vehicle” from the perspective of its operation and control, with other vehicles in the surrounding environment (which may be autonomous vehicles or non-autonomous vehicles) considered to be “non-ego vehicles” relative to the autonomous/ego vehicle.

The implementations discussed hereinafter, for example, will focus on a wheeled land vehicle such as a car, van, truck, bus, etc. In some implementations, the vehicle may be a truck configured to transport freight, and in some implementations, the vehicle may be a truck capable of hauling or towing a freight carrier, e.g., tractor unit or semi-truck. In such implementations, the prime mover 104 may include one or more electric motors and/or an internal combustion engine (among others), while energy source 106 may include a fuel system (e.g., providing gasoline, diesel, hydrogen, etc.), a battery system, solar panels or other renewable energy source, a fuel cell system, etc., and drivetrain 108 may include wheels and/or tires along with a transmission and/or any other mechanical drive components suitable for converting the output of prime mover 104 into vehicular motion, as well as one or more brakes configured to controllably stop or slow the vehicle and direction or steering components suitable for controlling the trajectory of the vehicle (e.g., a rack and pinion steering linkage enabling one or more wheels of vehicle 100 to pivot about a generally vertical axis to vary an angle of the rotational planes of the wheels relative to the longitudinal axis of the vehicle). In some implementations, combinations of powertrains and energy sources may be used, e.g., in the case of electric/gas hybrid vehicles, and in some instances multiple electric motors (e.g., dedicated to individual wheels or axles) may be used as a prime mover. In the case of a hydrogen fuel cell implementation, the prime mover may include one or more electric motors and the energy source may include a fuel cell system powered by hydrogen fuel.

Direction control 112 may include one or more actuators and/or sensors for controlling and receiving feedback from the direction or steering components to enable the vehicle to follow a desired trajectory. Powertrain control 114 may be configured to control the output of powertrain 102, e.g., to control the output power of prime mover 104, to control a gear of a transmission in drivetrain 108, etc., thereby controlling a speed and/or direction of the vehicle. Brake control 116 may be configured to control one or more brakes that slow or stop vehicle 100, e.g., disk or drum brakes coupled to the wheels of the vehicle.

Other vehicle types, including but not limited to off-road vehicles, all-terrain or tracked vehicles, construction equipment, etc., will necessarily utilize different powertrains, drivetrains, energy sources, direction controls, powertrain controls and brake controls, as will be appreciated by those of ordinary skill having the benefit of the instant disclosure. Moreover, in some implementations some of the components may be combined, e.g., where directional control of a vehicle is primarily handled by varying an output of one or more prime movers. Therefore, the technical solutions described herein are not limited to the particular application of the herein-described techniques in an autonomous wheeled land vehicle.

In the illustrated implementation, autonomous control over vehicle 100 (which may include various degrees of autonomy as well as selectively autonomous functionality) is primarily implemented in a primary vehicle control system 120, which may include one or more processors 122 and one or more memories 124, with each processor 122 configured to execute program code instructions 126 stored in a memory 124.

A primary sensor system 130 may include various sensors suitable for collecting information from a vehicle's surrounding environment for use in controlling the operation of the vehicle. For example, a satellite navigation (SATNAV) sensor 132, e.g., compatible with any of various satellite navigation systems such as GPS, GLONASS, Galileo, Compass, etc., may be used to determine the location of the vehicle on the Earth using satellite signals. Radio Detection And Ranging (RADAR) and Light Detection and Ranging (LIDAR) sensors 134, 136, as well as one or more digital cameras 138 (which may include various types of image capture devices or image sensors capable of capturing still and/or video imagery), may be used to sense stationary and moving objects within the immediate vicinity of a vehicle. An inertial measurement unit (IMU) 140 may include multiple gyroscopes and accelerometers capable of detecting linear and rotational motion of a vehicle in three directions, while one or more wheel encoders 142 may be used to monitor the rotation of one or more wheels of vehicle 100.

The outputs of sensors 132-142 may be provided to a set of primary control subsystems 150, including, a localization subsystem 152, a planning subsystem 154, a perception subsystem 156, and a control subsystem 158. Localization subsystem 152 is principally responsible for precisely determining the location and orientation (also sometimes referred to as “pose”, which in some instances may also include one or more velocities and/or accelerations) of vehicle 100 within its surrounding environment, and generally within some frame of reference. Planning subsystem 154 is principally responsible for planning a trajectory or path of motion for vehicle 100 over some timeframe given a desired destination as well as the static and moving objects within the environment, while perception subsystem 156 is principally responsible for detecting, tracking, and/or identifying elements within the environment surrounding vehicle 100. Control subsystem 158 is principally responsible for generating suitable control signals for controlling the various controls in control system 110 in order to implement the planned trajectory or path of the vehicle. Any or all of localization subsystem 152, planning subsystem 154, perception subsystem 156, and control subsystem 158 may have associated data that is generated and/or utilized in connection with the operation thereof, and that may be communicated to a remote teleassist system in some implementations, e.g., using a teleassist subsystem 160.

In addition, an atlas or map subsystem 162 may be provided in the illustrated implementations to describe the elements within an environment and the relationships therebetween. Atlas subsystem 162 may be accessed by each of the localization, planning and perception subsystems 152-156 to obtain various information about the environment for use in performing their respective functions. Atlas subsystem 162 may be used to provide map data to the autonomous vehicle control system, which may be used for various purposes in an autonomous vehicle, including for localization, planning, and perception, among other purposes. Map data may be used, for example, to lay out or place elements within a particular geographical area, including, for example, elements that represent real world objects such as roadways, boundaries (e.g., barriers, lane dividers, medians, etc.), buildings, traffic devices (e.g., traffic or road signs, lights, etc.), as well as elements that are more logical or virtual in nature, e.g., elements that represent valid pathways a vehicle may take within an environment, “virtual” boundaries such as lane markings, or elements that represent logical collections or sets of other elements. Map data may also include data that characterizes or otherwise describes elements in an environment (e.g., data describing the geometry, dimensions, shape, etc. of objects), or data that describes the type, function, operation, purpose, etc., of elements in an environment (e.g., speed limits, lane restrictions, traffic device operations or logic, etc.). In some implementations, atlas subsystem 162 may provide map data in a format in which the positions of at least some of the elements in a geographical area are defined principally based upon relative positioning between elements rather than any absolute positioning within a global coordinate system. It will be appreciated, however, that other atlas or map systems suitable for maintaining map data for use by autonomous vehicles may be used in other implementations, including systems based upon absolute positioning. Furthermore, it will be appreciated that at least some of the map data that is generated and/or utilized by atlas subsystem 162 may be communicated to a teleassist system in some implementations.

It will be appreciated that the collection of components illustrated in FIG. 1 for primary vehicle control system 120 is merely exemplary in nature. Individual sensors may be omitted in some implementations, multiple sensors of the types illustrated in FIG. 1 may be used for redundancy and/or to cover different regions around a vehicle, and other types of sensors may be used. Likewise, different types and/or combinations of control subsystems may be used in other implementations. Further, while subsystems 152-162 are illustrated as being separate from processors 122 and memory 124, it will be appreciated that in some implementations, some or all of the functionality of a subsystem 152-162 may be implemented with program code instructions 126 resident in one or more memories 124 and executed by one or more processors 122, and that these subsystems 152-162 may in some instances be implemented using the same processors and/or memory. Subsystems in some implementations may be implemented at least in part using various dedicated circuit logic, various processors, various field-programmable gate arrays (“FPGA”), various application-specific integrated circuits (“ASIC”), various real time controllers, and the like, and as noted above, multiple subsystems may utilize common circuitry, processors, sensors, and/or other components. Further, the various components in primary vehicle control system 120 may be networked in various manners.

In some implementations, vehicle 100 may also include a secondary vehicle control system 170, which may be used as a redundant or backup control system for vehicle 100. In some implementations, secondary vehicle control system 170 may be capable of fully operating autonomous vehicle 100 in the event of an adverse event in primary vehicle control system 120, while in other implementations, secondary vehicle control system 170 may only have limited functionality, e.g., to perform a controlled stop of vehicle 100 in response to an adverse event detected in primary vehicle control system 120. In still other implementations, secondary vehicle control system 170 may be omitted.

In general, a number of different architectures, including various combinations of software, hardware, circuit logic, sensors, networks, etc. may be used to implement the various components illustrated in FIG. 1. Each processor may be implemented, for example, as a microprocessor and each memory may represent the random access memory (RAM) devices comprising a main storage, as well as any supplemental levels of memory, e.g., cache memories, non-volatile or backup memories (e.g., programmable or flash memories), read-only memories, etc. In addition, each memory may be considered to include memory storage physically located elsewhere in vehicle 100, e.g., any cache memory in a processor, as well as any storage capacity used as a virtual memory, e.g., as stored on a mass storage device or on another computer or controller. One or more processors illustrated in FIG. 1, or entirely separate processors, may be used to implement additional functionality in vehicle 100 outside of the purposes of autonomous control, e.g., to control entertainment systems, to operate doors, lights, convenience features, etc.

In addition, for additional storage, vehicle 100 may also include one or more mass storage devices, e.g., a floppy or other removable disk drive, a hard disk drive, a direct access storage device (DASD), an optical drive (e.g., a CD drive, a DVD drive, etc.), a solid state storage drive (SSD), network attached storage, a storage area network, and/or a tape drive, among others. Furthermore, vehicle 100 may include a user interface 172 to enable vehicle 100 to receive a number of inputs from and generate outputs for a user or operator, e.g., one or more displays, touchscreens, voice and/or gesture interfaces, buttons, and other tactile controls, etc. Otherwise, user input may be received via another computer or electronic device, e.g., via an app on a mobile device or via a web interface, e.g., from a remote operator.

Moreover, vehicle 100 may include one or more network interfaces, e.g., network interface 174, suitable for communicating with one or more networks 176 (e.g., a LAN, a WAN, a wireless network, and/or the Internet, among others) to permit the communication of information with other vehicles, computers and/or electronic devices, including, for example, a central service, such as a cloud service, from which vehicle 100 receives environmental and other data for use in autonomous control thereof. In the illustrated implementations, for example, vehicle 100 may be in communication with various cloud-based first party remote vehicle services 178 including, for example, atlas or map services or systems, teleassist services or systems, live map services or systems, logging services or systems, fleet services or systems, etc. In addition, as illustrated in FIG. 1, vehicle 100 may also be in communication with various cloud-based third party remote services 180, which may be used, for example, to supply services to autonomous vehicle 100 and/or a first party remote service, and/or to receive notifications from autonomous vehicle and/or a first party remote service, e.g., for the purpose of notifying shippers, carriers, customers, governmental authorities, etc. of events detected by an autonomous vehicle.

An atlas or map service or system provided as a remote service 178 may be used, for example, to maintain a global repository describing one or more geographical regions of the world, as well as to deploy portions of the global repository to one or more autonomous vehicles, to update the global repository based upon information received from one or more autonomous vehicles, and to otherwise manage the global repository. A teleassist service or system provided as a remote service 178 may be used, for example, to provide teleassist support to vehicle 100, e.g., through communication with teleassist subsystem 160 resident in primary vehicle control system 120. A live map service or system provided as a remote service 178 may be used to propagate various observations collected by one or more autonomous vehicles to effectively supplement the global repository maintained by an atlas or map service or system. The terms “service” and “system” are generally used interchangeably herein, and generally refer to any computer functionality capable of receiving data from, and providing data to, an autonomous vehicle. In many instances, these services or systems may be considered to be remote services or systems insofar as they are generally external to an autonomous vehicle and in communication therewith.

As used herein, a “first-party entity” is an entity that develops, maintains, and/or controls primary vehicle control system 120, and may or may not manufacture vehicle 100 itself. Some non-limiting examples of first-party entities can include, for example, a manufacturer of primary vehicle control system 120, a dispatcher that dispatches vehicle 100 along a navigation route, a teleassist operator that can remotely control vehicle in certain situations (e.g., failure of vehicle 100, failure of certain component(s) of vehicle 100, etc.), and/or other first-party entities. Further, a “third-party entity” is an entity that is distinct from the first-party entity that develops, maintains, and/or controls primary vehicle control system 120. Some non-limiting examples of third-party entities can include, for example, a shipper associated with a payload vehicle (e.g., in situations where vehicle 100 is an autonomous tractor-trailer), a carrier associated with a trailer of vehicle 100 (e.g., in situations where vehicle 100 is an autonomous tractor-trailer), a governmental authority, a service technician that performs maintenance of vehicle 100, an original equipment manufacturer (OEM) of vehicle 100 (where not also a first party), a fuel station attendant that services vehicle 100, a public serviceperson attempting to access vehicle 100 (e.g., public safety officer, transit authority, fire personnel, law enforcement, etc.), and/or other third-party entities.

Each processor illustrated in FIG. 1, as well as various additional controllers and subsystems disclosed herein, generally operates under the control of an operating system, and executes or otherwise relies upon various computer software applications, components, programs, objects, modules, data structures, etc., as will be described in greater detail below. Moreover, various applications, components, programs, objects, modules, etc. may also execute on one or more processors in another computer coupled to vehicle 100 via network, e.g., in a distributed, cloud-based, or client-server computing environment, whereby the processing required to implement the functions of a computer program may be allocated to multiple computers and/or services over a network. Further, in some implementations data recorded or collected by a vehicle may be manually retrieved and uploaded to another computer or service for analysis.

In general, the routines executed to implement the various implementations described herein, whether implemented as part of an operating system or a specific application, component, program, object, module, machine learning model, or sequence of instructions, or even a subset thereof, will be referred to herein as “program code.” Program code typically comprises one or more instructions that are resident at various times in various memory and storage devices, and that, when read and executed by one or more processors, perform the steps necessary to execute steps or elements embodying the various aspects of the technical solutions described herein. Moreover, while the technical solutions described herein have and hereinafter will be described in the context of fully functioning computers and systems, it will be appreciated that the various implementations described herein are capable of being distributed as a program product in a variety of forms, and utilizing various types of computer readable media to actually carry out the distribution. Examples of computer readable media include tangible, non-transitory media such as volatile and non-volatile memory devices, floppy and other removable disks, solid state drives, hard disk drives, magnetic tape, and optical disks (e.g., CD-ROMs, DVDs, etc.), among others.

In addition, various program code described hereinafter may be identified based upon the application within which it is implemented in a specific implementation. However, it should be appreciated that any particular program nomenclature that follows is used merely for convenience, and thus the technical solutions described herein should not be limited to use solely in any specific application identified and/or implied by such nomenclature. Furthermore, given the typically endless number of manners in which computer programs may be organized into routines, procedures, methods, modules, objects, and the like, as well as the various manners in which program functionality may be allocated among various software layers that are resident within a typical computer (e.g., operating systems, libraries, API's, applications, applets, etc.), it should be appreciated that the technical solutions described herein are not limited to the specific organization and allocation of program functionality described herein.

Those skilled in the art will recognize that the exemplary environment illustrated in FIG. 1 is not intended to be limiting. Indeed, those skilled in the art will recognize that other alternative hardware and/or software environments may be used.

### Autonomous Vehicle Transportation Hub and/or Environmental Monitoring

As noted above, transportation hubs can present particular challenges to the operation of autonomous vehicles. A transportation hub, in this regard, may be considered to be a facility where freight is loaded, unloaded, temporarily stored, and/or transferred. In many instances, the freight may be housed in an unpowered freight carrier such as a shipping container (also known as an intermodal freight container) or a trailer (e.g., a semi-trailer, a flatbed, a refrigerated trailer, a tandem trailer, etc.) that is detachably coupled to a drive or towing vehicle such as a semi-truck or tractor unit. It will be appreciated, however, that other manners of hauling and/or containing freight, including sea-based vehicles such as boats, barges and ships, and rail-based vehicles such as trains, may utilize transportation hubs. Further other types of freight hauling wheeled vehicles, including straight or box trucks, may utilize transportation hubs. Transportation hubs may be used with autonomous vehicles, non-autonomous vehicles, or a combination of autonomous and non-autonomous vehicles in various implementations.

One example of a transportation hub that may be monitored in the manner described herein is a trucking terminal or drop yard, where semi-trailers are typically dropped off by one semi-truck, temporarily stored in a designated storage location, and picked up by another semi-truck. Such facilities may be used, for example, to allow local semi-trucks to pick up freight carriers from local businesses and/or drop off freight carriers at local businesses, and over-the-road semi-trucks to haul the freight carriers longer distances between different cities, states, or countries. Such facilities may also be used to transfer freight carriers between over-the-road semi-trucks to accommodate even longer distances. Autonomous vehicles, for example, may be particularly useful in connection with over-the-road transportation of freight carriers, as such routes are predominantly over limited access highways that can present fewer challenges than navigating on local streets.

Another example of a transportation hub that may be monitored in the manner described herein is a container port, which is typically positioned along a navigable waterway such as a river, bay, gulf, or ocean, and which may be used to transfer shipping containers between large sea-based container ships and road-based trucks. Such facilities may also be capable of temporarily storing thousands of shipping containers at a time, and it will be appreciated that due to the volume of cargo handled by such facilities, congestion is often a concern, and road-based trucks may be subject to significant delays when attempting to pick up or drop off shipping containers. Similar concerns also exist with respect to other types of intermodal freight facilities, e.g., rail-based facilities such as Container On Freight Car (COFC) or Trailer on Freight Car (TOFC), which are used to transfer freight carriers between rail-based trains and road-based trucks.

Still other types of transportation hubs may be used to load or unload freight into or from a freight carrier, e.g., at a loading dock at a distribution center, fulfillment center, or manufacturing facility. A transportation hub may also, in some implementations, may be considered to include one or more of a storage and/or distribution facility, a terminal, an intermodal or multi-modal facility, a maintenance facility, a parking facility, a truck stop, or a regulatory checkpoint.

As noted above, a common challenge with many such transportation hubs is the decentralized nature of such facilities. Individual trucks, freight carriers, and even the facilities themselves are often owned and/or operated by separate parties (and those parties are often separate from the owner parties of the freight itself), and coordinating the activities of the multitude of parties involved in the transfer of freight within such facilities can be challenging. Freight carriers can easily be lost in a large facility, requiring time and labor to locate missing freight carriers, and in some instances causing backups that delay the pickup or drop off of other freight carriers by other operators. Limited labor and other facilities can also cause long lines or queues to form when a large number of freight carriers need to be picked up or dropped off within a narrow window of time, and operators may also find it difficult to even locate available storage locations in a facility when dropping off freight carriers.

Operating an autonomous vehicle such as an autonomous truck in such a potentially chaotic environment can present numerous challenges. Many transportation hubs, for example, do not constrain vehicles to specific roads or paths, so autonomous vehicles may have to navigate in the presence of other vehicles approaching from multiple directions, facility workers capable of walking around anywhere in the facility, and various stationary objects in the facility that limit visibility, e.g., around corners or behind occlusions. Further, for an autonomous truck such as an autonomous semi-truck or tractor unit, sensor visibility is often limited when pulling a trailer, as in many cases the trailer may be owned or controlled by a different party, and generally will not include any perception sensors capable of sensing the environment around the trailer. As such, in many instances the trailer itself presents a large blind spot in the field of view of the autonomous truck's own perception sensors.

In addition, the lack of coordination in many transportation hubs can also complicate the transfer of freight into or out of such facilities. Freight carriers such as trailers or shipping containers can easily be lost in a large facility, requiring time and labor to locate missing freight carriers, and in some instances causing backups that delay the pickup or drop off of other freight carriers by other operators. Limited labor and other facilities can also cause long lines or queues to form when a large number of freight carriers need to be picked up or dropped off within a narrow window of time, and operators may also find it difficult to even locate available storage locations in a facility when dropping off freight carriers. In some implementations, however, perception data collected by autonomous vehicles may be used to monitor transportation hubs, often in connection with the regular operation of such autonomous vehicles. The perception data, which may include, for example, sensor data collected from various types of perception sensors such as cameras or image sensors, LIDAR sensors, RADAR sensors, etc., may be used to identify one or more entities disposed within a transportation hub, and the one or more entities identified using the perception data may then be used to determine status information associated with the transportation hub. The perception data, in some implementations, may be collected while an autonomous vehicle is disposed within a transportation hub, while in some implementations, the collection of perception data may be performed while an autonomous vehicle is merely proximate to the transportation hub, e.g., when driving by the transportation hub within range of one or more perception sensors of the autonomous vehicle.

In this regard, an entity identified using perception data may include practically any object or element capable of being sensed in an environment, including stationary objects such as buildings, road and other surfaces, walls, fences, structures, signs, etc., as well as dynamic objects such as vehicles, freight carriers, individuals, animals, etc. Some identified entities may also be virtual or logical in nature, e.g., boundaries, driving paths, lanes, etc. The identification of entities may also include, beyond simply identifying the type, class or category of an entity, various properties about the entity, e.g., dimensions, colors, textual and/or graphical information visible on the entity, etc. For example, for a freight carrier such as a shipping container or trailer, identification of the entity may include determining identification information for the freight carrier, e.g., an identification number, a license plate number, or any other information suitable for uniquely identifying the freight carrier.

In addition, as will become more apparent below, the status information that may be determined using identified entities may be related to various aspects of the operation of a transportation hub or other facility. Status information in some implementations may include, for example, the locations and/or identities of freight carriers present in the transportation hub. Status information may also include the locations and/or identities of vehicles (autonomous and/or non-autonomous) present in the transportation hub. Status information may also include an identification of available storage locations (also referred to in some instances as available parking spaces) for freight carriers and/or vehicles, i.e., locations where freight carriers and/or vehicles may be stored or parked, whether in a transportation hub, or elsewhere in the environment.

Status information in some implementations may also include information regarding a line or queue in the transportation hub or another type of facility (e.g., a weigh station, inspection station, border station, etc.), e.g., where a plurality of vehicles are queued up waiting to perform some activity in the transportation hub such as picking up or dropping off freight carriers and/or freight carried by such freight carriers, undergoing inspection, maintenance, check-in, check-out, etc. The status information may include, for example, the number of vehicles waiting in the queue, an estimated wait time, etc. It will be appreciated, for example, that excessive waits (often referred to as detention) can result in lost productivity, lost wages for drivers, added shipping costs, etc., so status information associated with a line or queue may be useful in some implementations to avoid detention for some vehicles.

Status information may also include, in some implementations, information regarding various activities or events that may occur in a transportation hub. For example, incidents between identified entities may be determined in some implementations, e.g., accidents, collisions, hit and runs, etc. between different vehicles, with parked vehicles, with stationary objects, with stored freight carriers, or with individuals may be determined in some implementations. In addition, activity information, e.g., the current and/or historical statuses and/or activities of vehicles and/or individuals, may also be tracked in some implementations.

It will also be appreciated that status information determined by multiple autonomous vehicles may be compiled, e.g., by a service or system remote to the autonomous vehicles, to provide a continually updated status of the transportation hub. As freight carriers are dropped off and picked up by different vehicles, for example, a “live” or current inventory of freight carriers and their locations in the transportation hub may be maintained, as may an inventory of available storage locations and/or parking spaces. In addition, as the identities and number of vehicles in a queue changes over time, the progress of individual vehicles and the length of the queue may be continually monitored by different autonomous vehicles, enabling, for example, an estimated wait time to be determined based on the amount of time each vehicle in the queue takes to reach the front of the queue.

In addition, as will become more apparent below, the collected status information may be shared with various parties, e.g., shippers, carriers, operators, fleets, governmental authorities, and other autonomous vehicles (e.g., other autonomous vehicles in the same fleet). Various public or governmental authorities, e.g., police, customs, administrative offices, parking authorities, emergency offices, highway departments, etc. may be notified in response to some types of status information (e.g., incidents, hazards, etc.) in some implementations.

The manner in which status information may be shared may also vary in different implementations. In some implementations, for example, a live status map may be maintained and utilized by multiple parties. In some implementations, an Application Programming Interface (API) may be provided to return status information in response to requests from various parties, and summary reports may be generated and distributed to interested parties in some implementations. Sharing may be pushed in some implementations, e.g., to subscribed parties, or may be on demand, e.g., in response to requests or queries by requesting parties.

In addition, the status information may be used to control the autonomous vehicle within which the perception data is collected and/or to control another autonomous vehicle in the vicinity of that autonomous vehicle. For example, where the status information relates to the location or identification of a freight carrier, the status information may be used to control movement of an autonomous vehicle (e.g., by determining an appropriate trajectory, and in some instances, directing a control system of the autonomous vehicle to follow the determined trajectory) for pickup of the freight carrier. Similarly, where the status information relates to the availability of a storage location or parking space, the status information may be used to control movement of an autonomous vehicle to drop off a freight carrier in a particular storage location or park the autonomous vehicle in a particular parking space.

As will also become more apparent below, status information may also be collected for environments other than transportation hubs, including, for example, the general environment within which an autonomous vehicle regularly operates. For example, status information may be collected to maintain a map of available parking spaces in an environment (e.g., street parking, off-street parking, parking lots, etc.). Status information may also be collected for various types of occurrences and/or environmental hazards, e.g., stranded vehicles, vegetation growth, road hazards, objects in a roadway, potholes, and other road surface defects (including, in some implementations, the severity of such defects), litter accumulation, queues and associated wait times, etc.

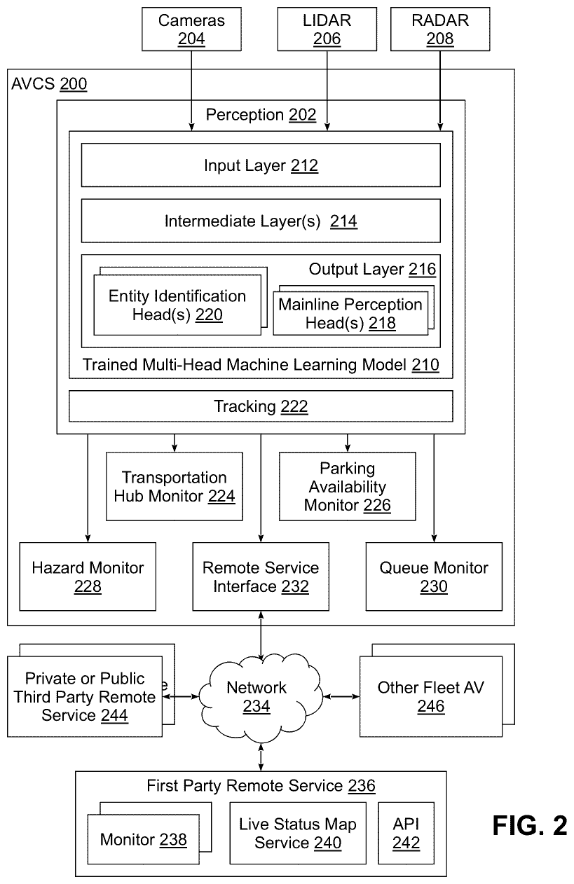

The manner in which perception data is collected, entities are identified, and status information is determined may vary in different implementations. For example, FIG. 2 illustrates an example system in which an autonomous vehicle control system 200 for an autonomous vehicle collects perception data, identifies one or more entities using the perception data, and determines status information from the one or more identified entities, at least for some types of status information.

Autonomous vehicle control system 200 includes a perception component or system 202 that receives as input perception data, e.g., as captured by one or more cameras or image sensors 204 (e.g., cameras with forward-facing, side-facing and/or rearward-facing fields of view), LIDAR data, e.g., as captured by one or more LIDAR sensors 206, and/or RADAR data, e.g., as captured by one or more RADAR sensors 208. Each of sensors 304, 306, 308 may be positioned on an autonomous vehicle to sense the roadway upon which the autonomous vehicle is disposed. Perception component 202 includes a trained multi-head machine learning model 210 that is configured to, in part, detect various objects or elements in the environment, as well as identify various entities in the environment surrounding the vehicle. A multi-head machine learning model, in this regard, may be considered to be a machine learning model including multiple output heads capable of generating different outputs or classifications, which are each generally tailored for detecting particular types of features or entities capable of being detected in the environment. In some implementations, for example, trained multi-head machine learning model 210 may be implemented as a deep neural network (DNN) including an input layer 212, one or more intermediate layers 214, and an output layer 216 including one or more mainline perception heads 218 and one or more entity identification heads 220. In some implementations, for example, one or more intermediate layers 214 may include one or more convolutional layers. The dimensions/shape of input layer 212 may be dependent on the shape of the perception data to be applied, while the dimensions/shape of each output head 218, 220 may be dependent on various factors such as how many class probabilities are to be predicted, among others. In some implementations, multiple convolution layers may be provided, and max pooling and/or other layers such as affine layers, softmax layers and/or fully connected layers may optionally be interposed between one or more of the convolution layers and/or between a convolution layer and the output layer. Other implementations may not include any convolution layer and/or not include any max pooling layers, and in still other implementations, other machine learning models may be used, e.g., Bayesian models, random forest models, Markov models, etc.

Each entity identification head 220, for example, may be configured to identify various entities from the environment from which status information about the environment may be determined. Also, a tracking module 222 may include one or more trackers capable of generating tracks for the various detected objects and entities over multiple frames. Trackers may render predictions of how existing tracks would appear in the sensor and then compare that rendering to incoming sensor data. When appropriate, the trackers may publish updates, which define a function that adjusts the track to better agree with the sensor data. Some of the trackers may also publish proposals for new tracks. The trackers may also be responsible for deleting tracks once they leave the sensors' field of vision (FOV) and are no longer perceived. In the illustrated implementation, for example, each tracker may take sensor data or the output of sensor data processing (“virtual” sensor data in the form of detections) as input, obtain existing tracks at the latest time before the time of the incoming measurements, associate relevant subsets of the sensor data or detections to the tracks, produce state updates for tracks with associated measurements, optionally generate proposals for new tracks from unassociated sensor data or detections, and publish updates and/or proposals for consumption by a track manager in the tracking module. In other implementations, some or all of the tracking may be integrated into model 210, rather than being implemented in a separate module.

The determination of some status information may be performed locally in the autonomous vehicle control system 200 using various monitors 224-230. A transportation hub monitor 224, for example, may be used to process the entities identified by model 210 to determine various status information associated with a transportation hub as described above. A parking availability monitor 226 may be used to process the entities identified by model 210 to determine various status information associated with occupied and available parking spaces in the environment. A hazard monitor 228 may be used to process the entities identified by model 210 to determine various status information associated with various environmental hazards that may be detected in the environment, and a queue monitor 230 may be used to process the entities identified by model 210 to determine various status information associated with one or more queues of vehicles detected in the environment.

In addition, a remote service interface 232 may be provided in autonomous vehicle control system 200 to interface with one or more remote services and/or devices over a network 234. For example, an autonomous vehicle control system may interface with a first party remote service 236, and may include, for example, one or more monitors 238, a live status map service 240, and/or an API 242.

Each monitor 238, for example, may be used to determine status information in a similar manner to one or more of monitors 224-230 and/or to collect status information generated by multiple autonomous vehicles. It will be appreciated, for example, that at least for some types of status information, the determination of that status information and/or the identification of the entities from which that status information is determined may be performed in remote service 236, and remote from an autonomous vehicle. As such, in some implementations, autonomous vehicle control system 200 may communicate data regarding the entities identified by model 210 to remote service 236 for a determination of status information from the received data. In addition, in some implementations, autonomous vehicle control system 200 may communicate perception data to remote service 236 for both the identification of entities and the determination of status information from the received perception data.

As each monitor 238 is in communication with multiple autonomous vehicles, regardless of whether the status information is determined in the remote service or in each autonomous vehicle, the status information determined from the perception data of multiple autonomous vehicles may be compiled and used to continually update a state of the environment, e.g., by overriding a prior state determined from one or more autonomous vehicles with status information from another autonomous vehicle, by confirming a prior state determined from one or more autonomous vehicles with status information from another autonomous vehicle, by combining states determined from multiple autonomous vehicles, etc.

In some implementations, for example, the collected status information may be used to generate one or more live status maps that provide a current state associated with various aspects of an environment, e.g., various transportation hubs, various parking areas, various queues, etc. Live status map service 240 may be used to maintain these live status maps based on the status information collected by monitors 238, and API 242 may interact with live status map service 240 to respond to requests or queries issued by various parties, including, for example, various components in remote service 236, various components in autonomous vehicles control system 200, as well as various private and/or public third party remote services 244 (e.g., governmental authorities, shippers, carriers, publicly-available websites, etc.) and other fleet autonomous vehicles 246. In addition, in some implementations, the collected status information may be used to provide insights/guidance on potential optimization opportunities for particular locations and/or operations. For example, the collected status information may be used to generate strategies for improving the efficiency/flow of a transportation hub. Similarly, for a municipality, the collected status information may be used to generate strategies for improved road layouts, signage, parking space availability, etc.

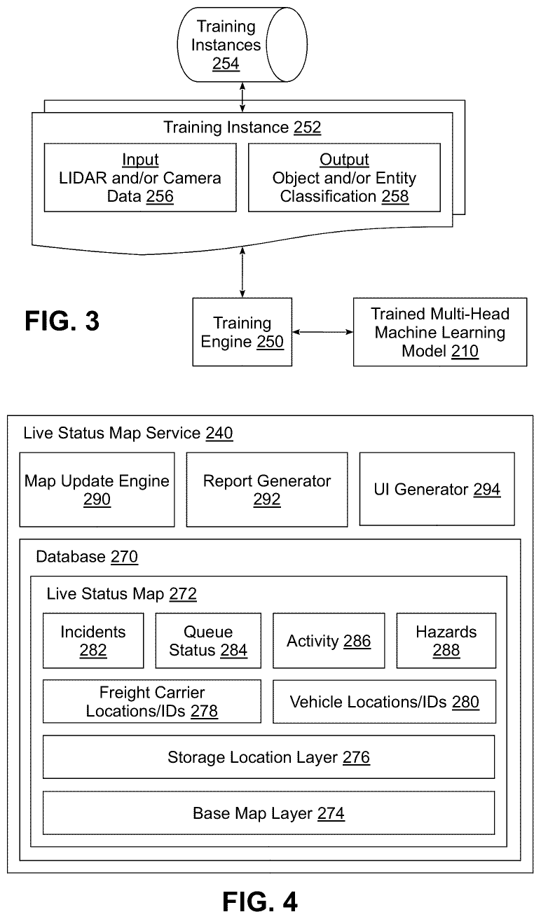

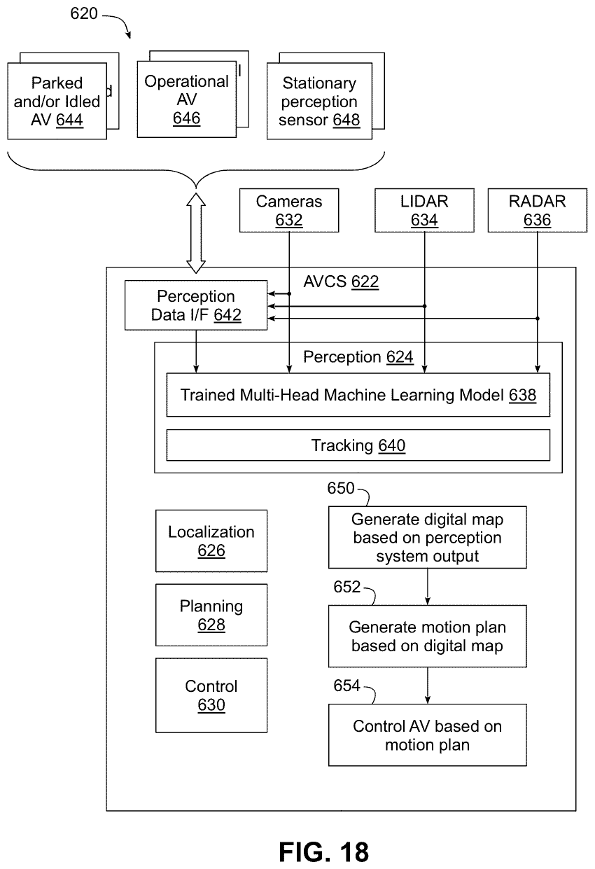

FIG. 3 next illustrates a system for training model 210, e.g., using a training engine 250 that utilizes training instances 252 retrieved from a training instances database 254. The input 256 of each training instance, for example, may include perception data such as LIDAR and/or camera/image data, and the output 258 of each training instance may include object and/or entity classifications. In some implementations, for example, the training instance output 258 may define, for each of a plurality of spatial regions, whether an object of one or more classes is present in the spatial region and/or whether an entity of one or more classes is present in the spatial region. In training model 210, training engine 250 may apply the training instance input 256 to model 210 and process the training instance input 256, utilizing model 210 and based on current parameters of model 210, to generate an output having a dimension that conforms to the dimension of training instance output 258. In addition, in some implementations, training instances may also include perception data such as LIDAR and/or camera/image data fused together from multiple perception sensors (e.g., on multiple vehicles and/or within a transportation hub) as described below in connection with FIG. 18, such that object and/or entity classification may be based in part on distributed perception techniques as described herein.

Training engine 250 may then compare the generated output to the training instance output 258, and update one or more parameters of model 210 based on the comparison. For example, training engine 250 may generate an error based on differences between the generated output and the training instance output 258, and backpropagate a loss (that is based on the error) over model 210 to update model 210. Although only a single training instance 252 is illustrated in FIG. 3, model 210 will generally be trained based on a large quantity of training instances of training instances database 254. Those training instances can collectively include training instance inputs with diverse perception data and diverse training instance outputs. Moreover, although non-batch training is described with respect to FIG. 3, batch training may additionally or alternatively be utilized (e.g., where losses are based on errors determined based on a batch of training instances).

As model 210 is a multi-head model that incorporates at least one mainline perception head 218 and at least one entity identification head 220, different subsets of training instances may be used, thereby co-training the different output heads 218, 220 and jointly optimizing the model for both mainline perception and entity identification functionality. At least one subset of the training instances may include input perception data associated with one or more objects sensed within the environment and output classification data that classifies one or more objects to be classified by the least one mainline perception head. At least one subset of the training instances may include input perception data associated with one or more entities identified within the environment and output classification data that classifies one or more entities to be classified by the least entity identification head. Furthermore, it will be appreciated that at least one training instance may be overlapping in nature, and may include perception data associated with multiple objects and/or multiple entities, thereby further jointly optimizing the model for both mainline perception and entity identification functionality.

FIG. 4 next illustrates an example implementation of live status map service 240 of FIG. 2 in greater detail. In this implementation, service 240 includes a database 270 in which is stored a live status map 272 including a base map layer 274 providing map data associated with the environment. In addition, where the map is used in connection with a transportation hub and/or parking availability, a storage location layer 276 is provided as an overlay to the base map layer, and includes the locations in which vehicles may park, as well as, in the case of a transportation hub, the locations in which freight carriers may be stored. Then, depending on the type of status maintained by the map, additional overlays may be provided relating to freight carrier locations (and if appropriate, identifications) 278, vehicle locations (and if appropriate, identifications) 280, incident information 282, queue status information 284, activity information 286, and hazard information 288.

A map update engine 290 may be used to update the status information maintained in map 272 based on new status information received from various autonomous vehicles, and a report generator 292 may be used to generate summary reports of the current and/or historical status information in the map. A user interface (UI) generator 296 may be used to generate graphical map displays of portions of the map, and optionally including various status information overlaid thereon. User requests, e.g., via API 242 of FIG. 2, may then be used to retrieve the various information generated by generators 294, 296 and/or other requests status information from map 272.

It will be appreciated that where a map is used only for certain types of status information (e.g., for a particular transportation hub, for a particular area, for a particular purpose, only a subset of the types of status information described herein may be maintained in map 272. Therefore, the technical solutions described herein are not limited to a map including all of the different types of status information discussed herein.

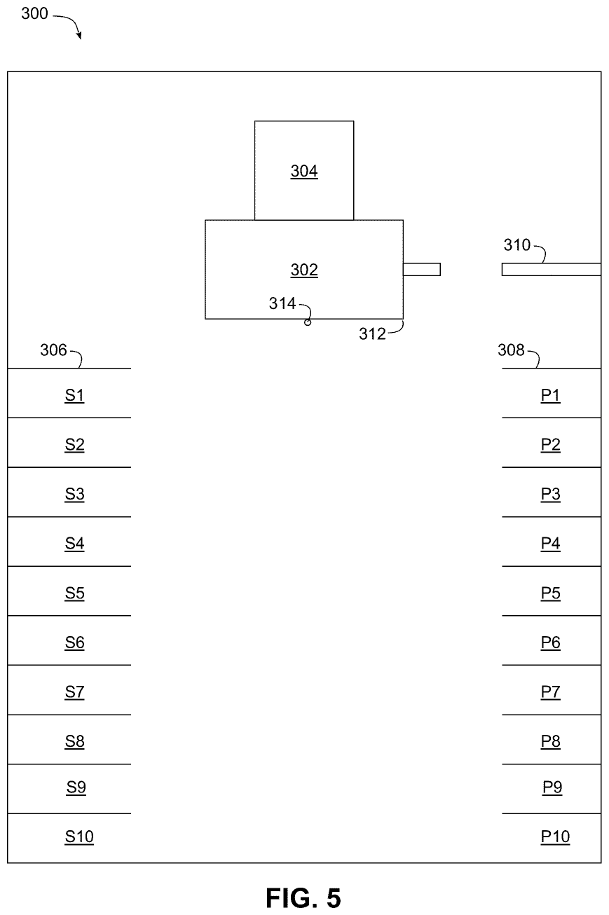

As an example of environmental monitoring utilizing a live status map for a transportation hub as described herein, FIG. 5 illustrates an example transportation hub 300, which includes a building 302, a covered check in area 304, a plurality of freight carrier storage locations 306, and a plurality of vehicle parking spaces 308. Also illustrated in FIG. 5 is an occluding element such as a wall 310, as well as a corner 312, both of which, as will be discussed in greater detail below, can limit the visibility of perception sensors of autonomous vehicles operating in the transportation hub. Also illustrated in FIG. 5 is a stationary perception sensor suite 314, which may be used to supplement the perception data available to an autonomous vehicle, as will be discussed in greater detail below in connection with FIG. 18.

Storage locations 306 may be assigned unique identifiers (e.g., S1-S10) and parking spaces may be assigned unique identifiers (e.g., P1-P10), such that, for example, a live status map of the transportation hub may identify the locations and identities of the storage locations and parking spaces in a storage location layer of the map, as described above in connection with FIG. 4.

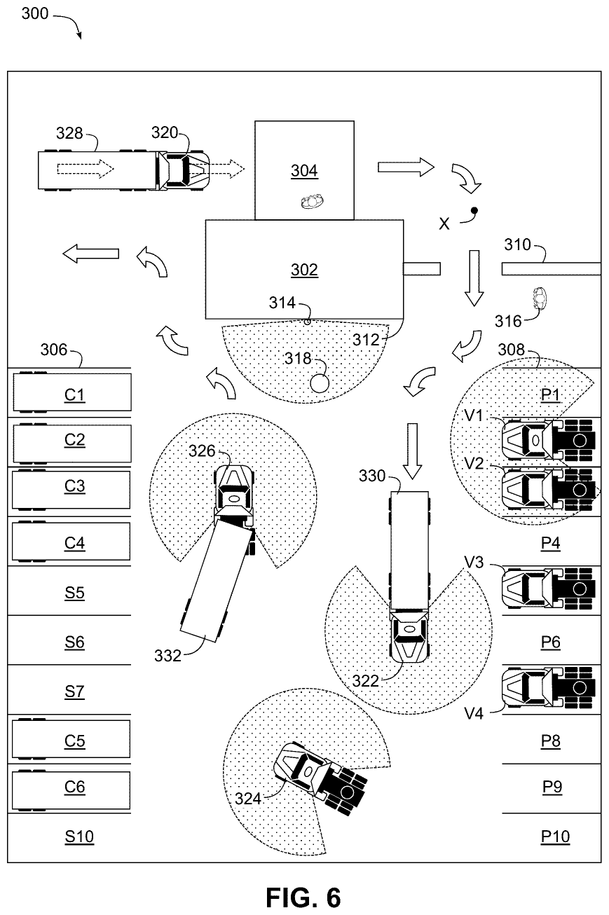

FIG. 6 next illustrates various entities that may be identified in the transportation hub, as well as several vehicles, both autonomous and non-autonomous, that may be operated and/or may be parked in the transportation hub. For example, an individual 316, such as a worker or vehicle operator, is illustrated, as well as is a potential hazard 318. Moreover, a non-autonomous vehicle 320 and a plurality of autonomous vehicles 322, 324, and 326 (e.g., autonomous trucks) are shown operating in the transportation hub, with vehicles 320, 322, and 326 towing freight carriers (semi-trailers) 328, 330, and 332, respectively. Arrows illustrate the general flow of traffic through the transportation hub, with vehicle 320 shown entering the hub, vehicle 322 ready to drop off a freight carrier, vehicle 324 ready to pick up a freight carrier, and vehicle 326 ready to exit the transportation hub after picking up a freight carrier.

FIG. 6 also illustrates a number of temporarily stored freight carriers having identifiers C1-C6 and locations S1-S4 and S8-S9, as well as a number of parked and idle vehicles having identifiers V1-V4 and locations P2-P3, P5, and P7. Vehicle V1 is an autonomous vehicle and vehicles V2-V4 are non-autonomous vehicles. It will be appreciated further that storage locations S5-S7 and S10 may be considered to be available storage locations and parking spaces P1, P4, P6, and P8-P10 may be considered to be available parking spaces, based upon the lack of assignment of freight carriers/vehicles to those storage locations/parking spaces. Finally, perception sensor fields of view for autonomous vehicles 322, 324, 326, and V1, as well as for stationary perception sensor suite 314, are illustrated by the stippled arcs in FIG. 6.

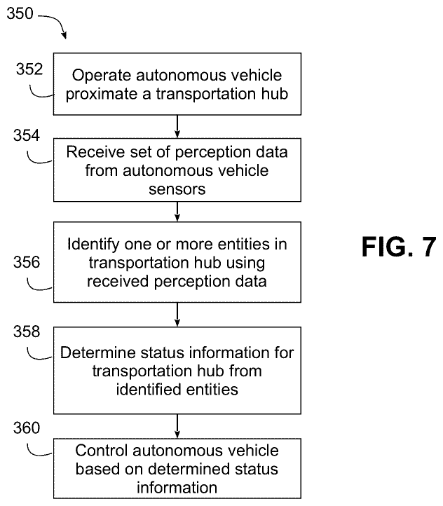

With continuing reference to FIGS. 5-6, FIG. 7 illustrates an example operational sequence 350 capable of being performed by an autonomous vehicle control system such as autonomous vehicle control system 200, either alone or in combination with a remote service such as remote service 236, to determine status information associated with a transportation hub and utilize that status information in its operation. In block 352, the autonomous vehicle is operated proximate to a transportation hub, either within the transportation hub, or outside the transportation hub but close enough to be in range of the autonomous vehicle's perception sensors. In block 354, a set of perception data is received from the perception sensors of the autonomous vehicle, and in block 356, one or more entities in the transportation hub are identified using the received perception data. In block 358, status information is determined for the transportation hub from the identified entities, and subsequently the autonomous vehicle is controlled based on the determined status information, e.g., to drop off a freight carrier in an available storage location, to park in an available parking space, to pick up a freight carrier in a storage location based on a detected identifier of the freight carrier, or to perform any other activity appropriate based on the determined status information. For example, with reference FIG. 6, autonomous vehicle 324 could identify freight carrier C5 as being located in storage location S8 (e.g., based on an identification number detected on a side of freight carrier C5 from the perception data) and accordingly position itself to pick up the freight carrier.

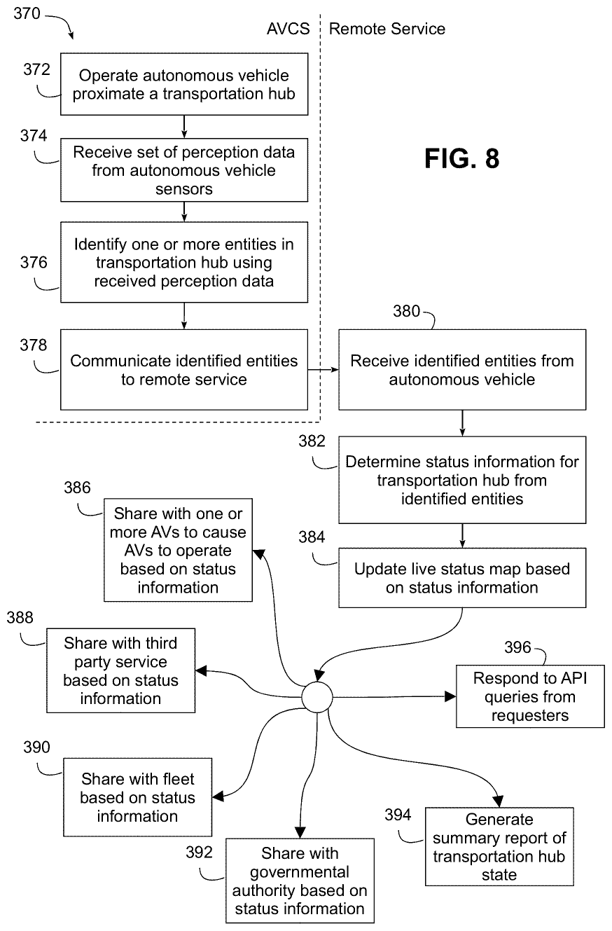

FIG. 8 next illustrates another example operational sequence 370 capable of being performed by an autonomous vehicle control system such as autonomous vehicle control system 200 in combination with a remote service such as remote service 236 to determine status information associated with a transportation hub and initiate the performance of various other operations based on the status information. In block 372, the autonomous vehicle is operated proximate to a transportation hub, either within the transportation hub, or outside the transportation hub but close enough to be in range of the autonomous vehicle's perception sensors. In block 374, a set of perception data is received from the perception sensors of the autonomous vehicle, and in block 376, one or more entities in the transportation hub are identified using the received perception data. In block 378, the identified entities are communicated to the remote service, and in block 380 the remote service receives the identified entities from the autonomous vehicle. Next, in block 382 status information is determined for the transportation hub from the identified entities by the remote service, and a live status map is updated based on the status information in block 384. Subsequently, one or more additional operations, represented by blocks 386-396, may be performed.

For example, as illustrated by block 386, data from the live status map may be shared with one or more autonomous vehicles to cause the autonomous vehicles to operate based on status information in the data. For example, with reference FIG. 6, and assuming that autonomous vehicle 326 identifies freight carrier C5 as being located in storage location S8 (e.g., based on an identification number detected on a side of freight carrier C5 from the perception data) as autonomous vehicle 326 drives through the transportation hub, the remote service may share the location of the freight carrier with another autonomous vehicle 324 to cause the other autonomous vehicle to position itself to pick up the freight carrier.

As another example, as illustrated by blocks 388-392, status information may be shared with a third party service (block 388), a fleet (block 390) and/or a governmental authority (block 392). Any of the aforementioned types of status information could be shared with any of these parties, e.g., storage location and/or parking space availability, freight carrier and/or vehicle locations and/or identifies, queue lengths, wait times, hazards, incidents, activity data, etc. As yet another example, a summary report of the current transportation hub state may be generated in block 394. Further, queries from various first and/or third party requesters may be responded to in block 396.

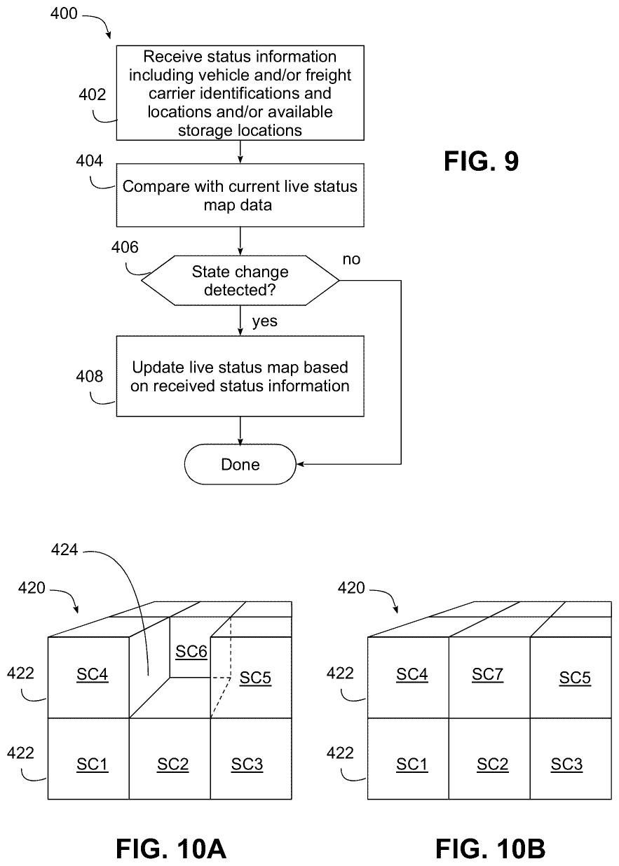

FIG. 9 next illustrates an example operational sequence 400 for updating a live status map such as live status map 272 of FIG. 4. In particular, in block 402, status information including, for example, vehicle and/or freight carrier identifications and/or locations, and/or available storage locations, is received. Next, in block 404, the received status information is compared with the current live status map data, and block 406 determines if a state change has occurred. If so, control passes to block 408 to update the live status map based on the received status information, and the sequence is complete. Returning to block 406, if no state change has occurred, sequence 400 completes after bypassing block 408.

For example, in some implementations, a live status map may map various vehicles and/or freight carriers identified from the status information to predetermined storage locations in the live status map. Available storage locations may be identified based upon such a mapping, and in particular, based upon a lack of assignment of any vehicle or freight carrier to a particular storage location. The mapping further enables the location of a vehicle or freight carrier to be identified based on input of an identifier for the vehicle or freight carrier, and conversely, for the identity of a vehicle or freight carrier to be determined based on input of a particular storage location to which that vehicle or freight carrier is mapped.

Now turning to FIGS. 10A-10B, in particular with regard to freight carriers such as shipping containers stored at a container port, it will be appreciated that the volume of shipping containers, as well as the multitude of parties involved with unloading/loading shipping containers from/to ships, picking up offloaded shipping containers, dropping off shipping containers to be loaded onto ships, etc., maintaining an accurate inventory of shipping containers present in the container port, as well as the locations of specific shipping containers, can be highly problematic in some circumstances. Further complicating this scenario is the fact that shipping containers can be stacked upon one another such that the identifications of individual shipping containers may not always be visible, such that some shipping containers may not be identifiable without moving other shipping containers that are hiding the sides of the obstructed shipping containers.

As illustrated in FIG. 10A, an example container port 420, for example, may include a stacked arrangement of shipping containers 422, each having a visible identifier (here identifiers SC1-SC6) that uniquely identifies the shipping container. In addition, as illustrated at 424, an available storage location, on top of shipping container SC2 and between shipping containers SC4 and SC5, may also exist. If, for example, at time T1 (corresponding to FIG. 10A), a first autonomous vehicle passes by the stack of shipping containers, the perception data of the autonomous vehicle may be capable of identifying that shipping containers identified as SC1-SC6 are stored in predetermined storage locations (not identified in FIG. 10A), and that an available storage location 424 exists on top of shipping container SC2.

Assume then that another shipping container, identified as shipping container SC7, is stacked on top of shipping container SC2. Then, as illustrated in FIG. 10B, when a second autonomous vehicle drives passes by the stack of shipping containers at a time T2, the perception data of the second autonomous vehicle may be capable of identifying that another shipping container identified as SC7 has been stored in the previously available storage location 424, and thus may update the live status map as described above in connection with FIG. 9. Moreover, by virtue of the prior mapping of shipping container SC6 to the storage location behind that of shipping container SC7, the location of shipping container SC6 is still maintained in the live status map, such that another vehicle seeking to pick up shipping container SC6, or alternatively, a loading mechanism seeking to load the shipping container on a ship, may be directed to the correct location in the container port, and despite the fact that the identifier for shipping container SC6 is no longer visible. As such, through the collective action of multiple autonomous vehicles driving through the container port, a current inventory of the shipping containers and their locations may be maintained on a substantially real-time basis, and in some instances, without requiring port personnel to manually log the locations of shipping containers as they are placed or removed onto or from various storage locations in the port.

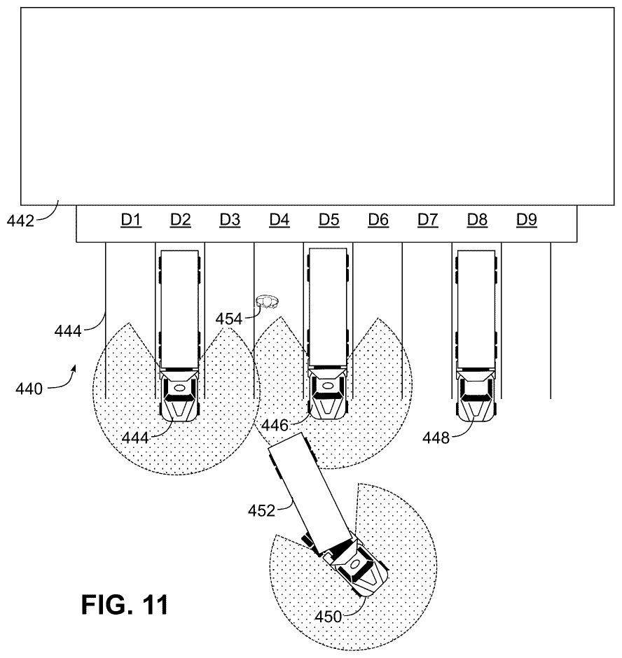

FIG. 11 next illustrates another example transportation hub 440, e.g., a loading dock, attached to a building 440 such as a distribution center, fulfillment center, manufacturing facility, etc. Loading dock 440 may include a plurality of storage locations, e.g., parking spaces 444, which may be identified based on corresponding locations on loading dock 440, e.g., D1-D9. Locations D1, D3-D4, D6-D7, and D9 are identified as available storage locations, while autonomous vehicles 444 and 446 are shown parked in locations D2 and D5, and non-autonomous vehicle 448 is shown parked in location D8. FIG. 11 also illustrates an autonomous vehicle 450 hauling a trailer 452 and backing into available storage location D4, as well as an individual 454 standing in the storage location. A further discussion of the operation of autonomous vehicle 450 when backing up into storage location D4 will be provided below in connection with FIG. 18.

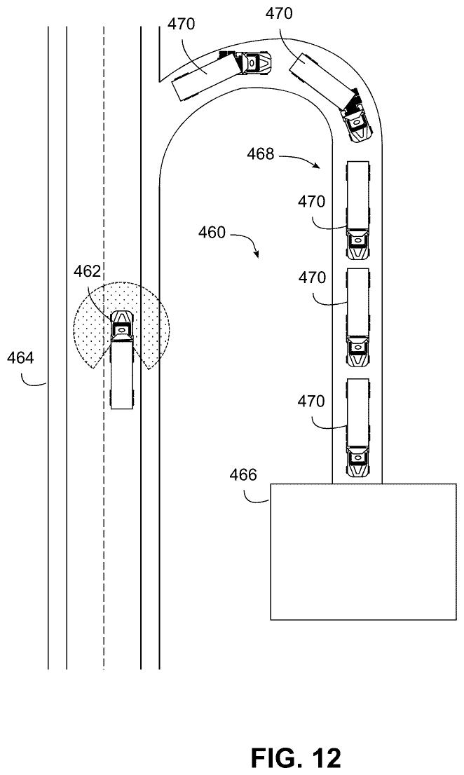

FIG. 12 next illustrates another example transportation hub 460, e.g., a distribution center, which is monitored by an autonomous vehicle 462 passing by the distribution center on a roadway 464, and including a facility 466 in which a queue has formed including a plurality of vehicles 470 waiting to perform a predetermined activity at facility 466. In other implementations, hub 460 could be a customs or border station, an inspection station, a container port, a terminal, a drop yard, or practically any other type of facility within which vehicles may queue from time to time. In this example, autonomous vehicle 462 does not even need to turn into the transportation hub, but instead may simply be traveling alongside the transportation hub en route to a different destination. Nonetheless, as autonomous vehicle 462 passes by the transportation hub, perception data collected from the sensors of the autonomous vehicle may be used to identify the number, and in some instances, the identities, of vehicles 470 waiting in queue 468.

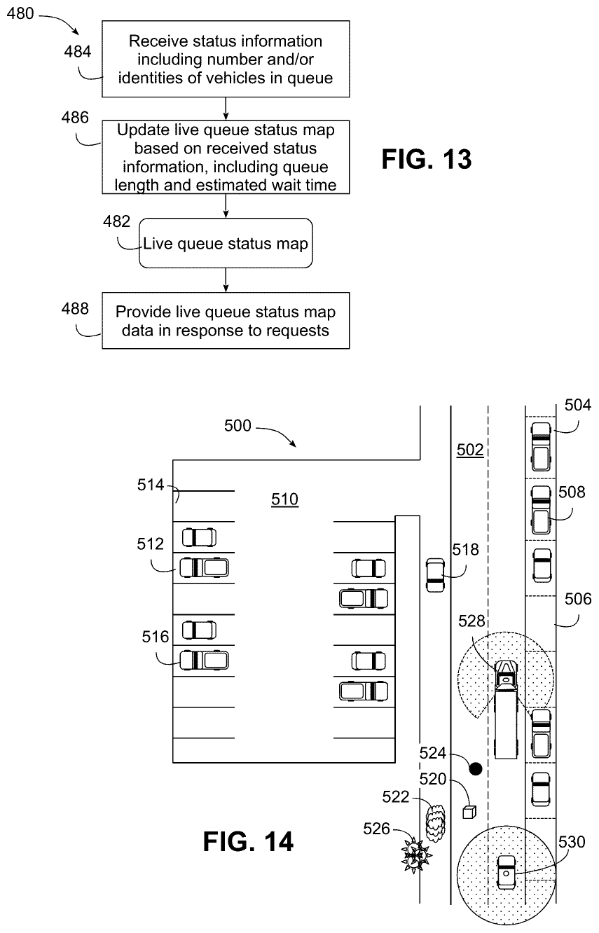

FIG. 13, for example, illustrates an example operational sequence 480 for updating a live queue status map 482, which may be implemented, for example, similar to live status map 272 of FIG. 4. In particular, in block 484, status information including, for example, the number of vehicles, as well as identities of at least some of the vehicles in the queue, may be received. Then, in block 486, live queue status map 482 may be updated based on the received status information, including the queue length (i.e., the number of vehicles currently in the queue) and an estimated wait time. Thereafter, in block 488, data from live queue status map 482 may be provided to various requesters in response to requests issued to the live status map service.

The identities of vehicles in some instances may be based on unique alphanumeric identifiers such as license plates or other unique identifiers visible on the vehicles or their trailers. In other instances, other identifying information, e.g., colors, patterns, shapes, models, types, etc., which may not necessarily uniquely identify a vehicle, may be used to distinguish vehicles in a queue from one another to assist in estimating waiting times for the queue. In some implementations, for example, so long as at least some of the vehicles are distinguishable from one another, the progress of one or more vehicles may be tracked based on the perception data of different autonomous vehicles and used to estimate a wait time for the queue. Status information from different autonomous vehicles passing by a queue, for example, may be timestamped such that, for example, if one identified vehicle in the queue is in the 4^{th} position at time T1, and in the 3^{rd} position at time T2, the time for each vehicle to perform the predetermined activity may be estimated from the difference between T2 and T1, such that the estimated time for a new vehicle to pass through the queue may be further estimated based on the number of vehicles ahead of it in the queue. Moreover, it will be appreciated that as additional status information is collected over time for the same and/or other vehicles, the accuracy of the time estimate for each vehicle may be improved, such that the overall wait time may be estimated as a function of the number X of vehicles in the queue and the per vehicle processing time estimate. As such, if it is estimated that each vehicle is processed at a rate of 12 minutes per vehicle, and there are 5 vehicles currently in the queue, the estimated wait time would be approximately 60 minutes.

Now turning to FIG. 14, as noted above the environmental monitoring techniques disclosed herein may be used in connection with monitoring environments other than transportation hubs. An example environment 500 is illustrated in FIG. 14, including a roadway 502 including a plurality of street parking spaces 504, a portion of which are available parking spaces 506 and another portion of which are occupied by vehicles 508. Also illustrated is off-street parking, e.g., a parking lot 510, which includes a plurality of parking spaces 512, a portion of which are available parking spaces 514 and another portion of which are occupied by vehicles 516. Environment 500 may also include various environmental hazards, e.g., a stranded or abandoned vehicle 518, an object 520 in the roadway, litter accumulation 522, a pothole 524, and vegetation growth 526 along the roadway. In this example, parking space availability for on- and/or off-street parking may be monitored, as many any or all of the aforementioned hazards 518-526, using perception data captured by one or more autonomous vehicles, e.g., an autonomous truck 528 and/or an autonomous car 530. In some implementations, for example, the perception data of an autonomous vehicle may be used to identify available parking spaces in an environment and generate data, e.g., embeddings, that indicate the location and/or availability status of individual parking spaces, and that may be utilized by a downstream consumer, e.g., to update a live parking availability map. In addition, in some implementations, environmental hazards may similarly be identified using the perception data of an autonomous vehicle and embeddings or other output data may be generated and communicated to a remote service (e.g., via an API supported by the remote service) for downstream consumption, e.g., for notification of third parties.

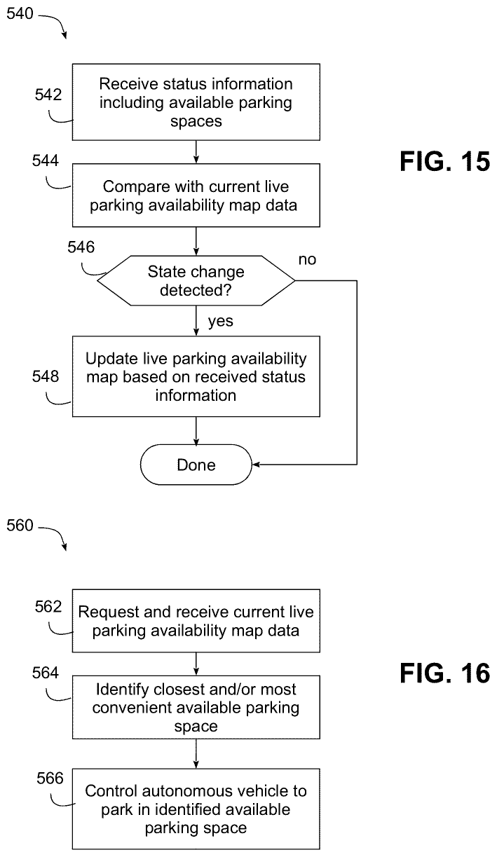

FIG. 15 illustrates an example operational sequence 540 for determining parking space availability in an environment such as environment 500 to update a live parking availability map, which may be implemented in a similar manner to live status map 272 of FIG. 4. In particular, in block 542, status information including, for example, available parking spaces, is received from one or more autonomous vehicles such as autonomous vehicles 528, 530. The status information may be determined, for example, using entities identified from perception data captured by the sensors of autonomous vehicles 528, 530. Next, in block 544, the received status information is compared with the current live parking availability map data, and block 546 determines if a state change has occurred. If so, control passes to block 548 to update the live parking availability map based on the received status information, and the sequence is complete. Returning to block 546, if no state change has occurred, sequence 540 completes after bypassing block 548.

Similar to updating a live status map as described above in connection with FIG. 9, in some implementations, a live parking availability map may map various vehicles identified from the status information to predetermined parking spaces in the live parking availability map. With a live parking availability map used in an environment other than a transportation hub, however, identification of specific vehicles may not be useful or desired, so in some implementations only the occupied status of each parking space may be tracked, rather than mapping specific vehicles to specific parking spaces. In addition, while in some implementations, each parking space may be mapped and effectively permanently defined in the map, in other implementations some parking spaces may be dynamically defined, e.g., where on-street parking does not delimit specific parking spaces. In such instances, an available parking space may be determined based on detection of sufficient empty space along the side of the roadway, and furthermore, map data, such as a mapping of valid areas to park (e.g., areas that are not within a predetermined distance from a corner, that are not within a predetermined distance from a fire hydrant, that do not block driveways, etc.) may also be used in the determination of whether an unoccupied space along a roadway is an available and legal parking space.

FIG. 16 next illustrates a complementary operational sequence 560 for operating an autonomous vehicle based on parking space availability consistent with some implementations. In block 562, for example, a request is issued on behalf of an autonomous vehicle to receive current live parking availability map data from the live parking availability map, e.g., for an area in the immediate vicinity of the autonomous vehicle. Next, in block 564 a closest and/or most convenient available parking space among the available parking spaces identified in the received live parking availability map data is identified, and in block 566, the autonomous vehicle is controlled (e.g., based on following a computed trajectory) to autonomously park in the identified available parking space.

It will be appreciated that in different implementations, the use of available parking space map data may be by the same autonomous vehicle from which the perception data used to identify the available parking space, a different autonomous vehicle, or even a non-autonomous vehicle. Moreover, the collection of perception data used to update a live parking availability map in some implementations may be made by autonomous vehicles that ultimately do not park in any available parking space, but that are merely operating within the environment.

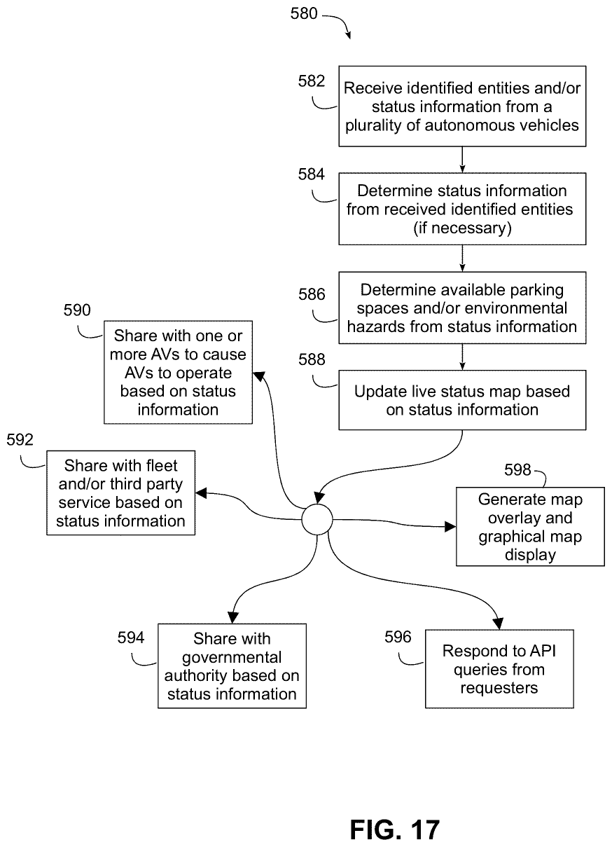

FIG. 17 next illustrates an example operational sequence 580 capable of being performed by a remote service such as remote service 236 of FIG. 2 for updating and using a live status map for an environment, e.g., to provide status information such as parking availability and/or environmental hazards. In block 582, the remote service receives identified entities and/or status information from a plurality of autonomous vehicles operating in the environment, and in block 584 status information from any received identified entities is determined, if necessary. Next, in block 586, available parking spaces and/or environmental hazards are determined from the status information, and in block 588, the live status map is updated based on the status information (e.g., to update parking space availability and/or the presence of various environmental hazards).

Once the live status map is updated, various additional operations, represented by blocks 590-598, may be performed. For example, as illustrated by block 590, data from the live status map may be shared with one or more autonomous vehicles to cause the autonomous vehicles to operate based on status information in the data. For example, with reference FIG. 14, and assuming that autonomous vehicle 528 identifies an available parking space 506 and/or an environmental hazard such as pothole 524, another autonomous vehicle such as autonomous vehicle 530 may either utilize the identified available parking space to park, or otherwise avoid navigating into the pothole.

As another example, as illustrated by blocks 592 and 594, status information may be shared with a fleet or third party service (block 592) and/or a governmental authority (block 594). Any of the aforementioned types of status information could be shared with any of these parties, e.g., parking space availability, environmental hazards, etc. Particularly with respect to environmental hazards and/or parking space availability, sharing with a governmental authority and/or members of the general public (e.g., via publication through a third party service) may provide a public service that is appreciated by the public at large. As yet another example, queries from various first and/or third party requesters issued through an API may be responded to in block 596. Environmental hazards, for example, may be useful for notifying governmental authorities, e.g., to trigger road repair, cleanup, police, towing, etc. Parking space availability, for example, may be useful for distributing to individuals through a web or mapping service, or through a map or navigation application or service, to enable an autonomous vehicle to navigate to a particular parking space, or alternatively, to enable a driver of a non-autonomous vehicle to be guided to a particular parking space.

Further, as illustrated in block 598, it may be desirable in some implementations to generate a graphical map display with a map overlay including the locations of available parking spaces and/or environmental hazards. As discussed above in connection with FIG. 4, for example, a live status map may be implemented in some implementations using a base map layer containing fundamental map data regarding static elements in the area, and to present additional information, e.g., environmental hazards and available parking spaces, as map overlays, and as such, graphical map displays may be generated and communicated/displayed to requesting users with various status information overlaid thereon in some implementations.

Other types of status information, as well as other manners of sharing such status information with end users, may be used in other implementations. For example, monitoring may also be performed in some instances of various other activities that may occur in an environment, e.g., interactions involving vehicles other than the autonomous vehicle, predetermined operations performed by vehicles other than the autonomous vehicle, identification of vehicles matching predetermined characteristics or identifiers (e.g., identifying a vehicle involved with an amber alert based on a license plate number or vehicle description), etc. Therefore, the technical solutions described herein are not limited to the particular types and uses of status information as described herein.

### Autonomous Vehicle Distributed Perception System

In some implementations, it may also be desirable to share perception data between autonomous vehicles, and in some instances, with stationary perception sensor suites, to supplement the perception data collected locally by an autonomous vehicle with additional perception data collected in the vicinity of the autonomous vehicle. As noted above, particularly in relatively chaotic and/or freeform areas such as transportation hubs, as well as in connection with autonomous vehicles that may have reduced fields of view (e.g., semi-trucks hauling semi-trailers), the lack of sufficient perception sensor coverage (e.g., due to blind spots in the perception sensors' field of view) can potentially limit the ability of an autonomous vehicle to detect objects in its vicinity, and further limit its ability to operate in an autonomous manner.

In some implementations, however, a distributed perception system may be utilized in an autonomous vehicle in which perception data captured or collected by one or more perception sensors of the autonomous vehicle during operation of the autonomous vehicle is utilized along with additional perception data captured or collected by one or more perception sensors of a different autonomous vehicle in the vicinity of the first autonomous vehicle to control movement of the autonomous vehicle. In some implementations, the autonomous vehicle that is controlled is towing a freight carrier in a transportation hub, and the additional perception data collected by the other autonomous vehicle is captured or collected while the other autonomous vehicle is parked in the transportation hub, and at least partially covers a blind spot of the autonomous vehicle that is being controlled (e.g., an area around the autonomous vehicle, and in particular its perception sensors, that is blocked by the towed freight carrier, such as the area behind the freight carrier). In some implementations, the blind spot may also result from an occlusion proximate the controlled autonomous vehicle, and in some implementations, the blind spot may be around a corner of a building or other structure proximate to the controlled autonomous vehicle. In addition, as will become more apparent below, a distributed perception system may be particularly useful in backing up autonomous vehicles, and in particular autonomous vehicles towing trailers or other freight carriers, as well as assisting such vehicles in navigating past occlusions and/or navigating around corners.

FIG. 18, for example, illustrates an example autonomous vehicle 620 including a distributed perception system consistent with some implementations. An autonomous vehicle control system 622 of autonomous vehicle 620 includes a perception system 624, localization system 626, planning system 628 and control system 630, similar to autonomous vehicle 100 of FIG. 1. In addition, perception system 624 receives perception data from a plurality of on-board perception sensors, e.g., one or more cameras or image sensors 632, one or more LIDAR sensors 634 and/or one or more RADAR sensors 636, which provide perception data to a trained multi-head machine learning model 638 similar to model 210 of FIG. 2. Perception system 624 may also include a tracking module 640 similar to tracking module 222 of FIG. 2.

Autonomous vehicle control system 622 additionally includes a perception data interface module 642, which is used to exchange perception data with one or more other perception systems and/or perception sensors that are remote from autonomous vehicle 620. For example, perception data interface module 642 may receive perception data from a parked and/or idled autonomous vehicle 644 in the vicinity of autonomous vehicle 620. In this regard, a parked autonomous vehicle is an autonomous vehicle that is stopped and not currently in gear or otherwise configured to move forward or backward under power in the absence of any braking. An idle autonomous vehicle is an autonomous vehicle that is not in an active operational state, e.g., with an engine or other prime mover fully turned off. An idle autonomous vehicle, for example, may be in a state where only a subset of the operational systems in the autonomous vehicle are active, and in some instances, only the perception sensors and the related components needed to communicate with a remote service and/or other autonomous vehicles. Put another way, an idle autonomous vehicle within the context of the present disclosure is in a non-operational state, and potentially in a low power state, and is generally not currently processing any active tasks related to driving or navigation.

In contrast, an operational autonomous vehicle may be considered to be an autonomous vehicle that is in motion, or, if stopped, in the process of driving or navigating to a different location or otherwise performing an active task. As illustrated in block 646, perception data collected by an operational autonomous vehicle may also be provided to perception data interface module 642 in some implementations, and it will be appreciated that, at least within the context of a transportation hub, an operational autonomous vehicle in many instances will be a vehicle that is in the process of picking up and/or dropping off a freight carrier and/or freight stored in a freight carrier, whether or not that autonomous vehicle is currently in motion at any particular time in connection with performing such activities.

Furthermore, in some implementations, perception data may also be received from one or more stationary perception sensors 648, e.g., perception sensors mounted in stationary locations in a transportation hub such as on a building, on a pole, on a fence, or in other locations having visibility into the transportation hub.

The perception data received from parked and/or idled autonomous vehicles 644, operation autonomous vehicles 646, and/or stationary perception sensors 648 is received by perception data interface module 642 and provided as additional perception data to perception system 624, e.g., as additional input to model 238. It will be appreciated that various data processing operations may be performed in some implementations to appropriately transform the perception data based upon the locations of the associated perception sensors relative to autonomous vehicle 620. For example, it may be desirable to transform any received LIDAR data to integrate the received LIDAR data with that received from LIDAR sensor(s) 634 to form a coherent point cloud from the perspective of autonomous vehicle 620.

It will also be appreciated that perception data interface module 642 may also be bidirectional in some implementations, and may output perception data collected from image sensors 632, LIDAR sensors 634 and/or RADAR sensors 636 to other autonomous vehicles for use thereby. In addition, in some implementations, the perception data that is shared between autonomous vehicles may include raw or processed perception sensor data (e.g., image, LIDAR, and/or RADAR sensor data), and in some implementations, the perception data that is shared between autonomous vehicle may include relatively higher level perception data output by one or more models of a perception system, e.g., one or more entities identified by a perception model from perception sensor data (e.g., including static objects, dynamic objects, and/or virtual objects such as boundaries or lanes), tracks associated with any identified entities, or practically any other data received by or output by a perception system of an autonomous vehicle. In some implementations, for example, an API may be supported to enable an autonomous vehicle to output perception data to one or more other autonomous vehicles and/or to enable an autonomous vehicle to receive perception data from one or more other autonomous vehicles.

Various data formats may be used to share perception data, e.g., embeddings, and perception data sharing may be implemented using various network architectures, e.g., via direct or peer-to-peer communication between nearby autonomous vehicles, via a site-specific service, via a broader remote service, etc. It will be appreciated that low latency communications and architectures may also be desirable in some instances in order to provide an autonomous vehicle with an up-to-date understanding of the current circumstances in the environment as it operates, particularly when the perception data includes perception sensor data that is integrated with on-board perception sensor data (e.g., to supplement any blind spots in the field of view of an autonomous vehicle's sensors). In this regard, an API and network architecture used to share perception data in some implementations may utilize embeddings having structures optimized for high-fidelity and low-latency communication, as well as compression and encoding suitable for optimizing the bandwidth and latency between autonomous vehicle perception systems. In some implementations, for example, embeddings output by one or more perception models of a perception system in one autonomous vehicle may be encoded for direct consumption by one or more perception models of the perception system of another autonomous vehicle, thereby streamlining an autonomous vehicle's determination of the current state of its surrounding environment using both on-board perception data of the autonomous vehicle and off-board perception data received from one or more other autonomous vehicles in the same area.

In addition, in some implementations, a service may utilize perception data shared by multiple autonomous vehicles in an area (e.g., a transportation hub) to generate and maintain a shared understanding or representation of the area that can be accessed by the autonomous vehicles, e.g., a collective map of perception data for the area. In some instances, the data may be pushed to all of the autonomous vehicles in the area, or alternatively, the data may be supplied on demand to individual autonomous vehicles.

As illustrated in blocks 650-654, autonomous vehicle control system 622 may operate in a similar manner to autonomous vehicle control system 200 of FIG. 2, and may follow a general flow of generating, in block 650, a digital map of the environment based on the perception system output (which is based in this instance on both local perception data and remote perception data from perception sensors that are external to the autonomous vehicle); generating a motion plan based on the digital map in block 652, and controlling the autonomous vehicle based on the motion plan in block 654. As such, perception data collected remotely from an autonomous vehicle may be used to supplement on-board perception data to further the situational awareness of an autonomous vehicle.

Returning to FIG. 6, for example, it may be seen that perception data collected from one or more parked and/or idle autonomous vehicles (e.g., parked and idle autonomous vehicle V1), one or more operational autonomous vehicles (e.g., autonomous vehicles 322, 324 and/or 326, and/or one or more stationary perception sensors such as one or more perception sensors in perception sensor suite 314 may be shared between various autonomous vehicles to address any potential blind spots in the fields of view of the on-board perception sensors of the autonomous vehicles. For example, parked and idle autonomous vehicle V1 may have a field of view that addresses blind spots caused by occlusions such as wall 310 and/or corners such as corner 312 such that, for example, an individual 316 hidden by wall 310 may be identified by an autonomous vehicle passing wall 310 from point X despite individual 316 being hidden from the on-board perception sensors of the autonomous vehicle. Similarly, an object such as object 318 hidden behind corner 312 may be identified by an autonomous vehicle turning around the corner from point X despite being effectively hidden behind the corner.

In addition, with reference to FIG. 11, a distributed perception system may be particularly useful in implementations where an autonomous vehicle, e.g., an autonomous truck 450 towing a freight carrier such as a semi-trailer 452, is backing into a storage location such as dock D4. It will be appreciated, in particular, that semi-trailers are often owned by different parties from the owners and/or operators of the semi-trucks that haul the semi-trailers, and as such, it is generally not desirable or even practicable to outfit semi-trailers with perception sensors, resulting in relatively large blind spots caused by the trailers blocking the fields of view of the perception sensors on the semi-trucks to which they are connected.

In the environment illustrated in FIG. 11, a pair of parked and idle autonomous vehicles 444, 446 may provide supplemental perception data to autonomous vehicle 450 to address the blind spot in autonomous vehicle 450's perception system due to semi-trailer 452, e.g., such that autonomous vehicle is made aware of individual 454 standing in the storage location corresponding to dock D4. In addition, the supplemental perception data may also be used to monitor the track of semi-trailer 452 as it is backed up to ensure that the trailer does not go off track and potentially collide with any surrounding mobile or stationary structures, as well as to confirm when the trailer is immediately adjacent the dock and suitable for loading and/or unloading.

As such, a distributed perception system as described herein may substantially improve the situational awareness of an autonomous vehicle, specifically in connection with operation in transportation hubs and/or when towing trailers. Other uses and applications of distributed perception systems as described herein will be appreciated by those of ordinary skill having the benefit of the instant disclosure, so the technical solutions described herein are not limited to the particular uses and applications described herein.

It will be appreciated that, while certain features may be discussed herein in connection with certain implementations and/or in connection with certain figures, unless expressly stated to the contrary, such features generally may be incorporated into any of the implementations discussed and illustrated herein. Moreover, features that are disclosed as being combined in some implementations may generally be implemented separately in other implementations, and features that are disclosed as being implemented separately in some implementations may be combined in other implementations, so the fact that a particular feature is discussed in the context of one implementation but not another should not be construed as an admission that those two implementations are mutually exclusive of one another.

What is claimed is:

1. A method implemented by one or more processors, the method comprising:
receiving perception data captured by one or more perception sensors of an autonomous vehicle during operation of the autonomous vehicle proximate a transportation hub;
identifying one or more entities disposed within the transportation hub using the perception data; and
determining status information for the transportation hub using the one or more entities identified using the perception data.

2. The method of claim 1, wherein identifying the one or more entities and determining the status information are performed by an autonomous vehicle control system resident in the autonomous vehicle.

3. The method of claim 1, wherein at least one of identifying the one or more entities and determining the status information are performed by a remote service in communication with an autonomous vehicle control system of the autonomous vehicle.

4. The method of claim 1, wherein the perception data is captured by the one or more sensors while the autonomous vehicle is disposed within the transportation hub.

5. The method of claim 1, wherein the perception data is captured by the one or more sensors while the autonomous vehicle is driving by the transportation hub.

6. The method of claim 1, wherein the autonomous vehicle is an autonomous truck configured to transport one or more freight carriers.

7. The method of claim 1, further comprising, in an autonomous vehicle control system of the autonomous vehicle, controlling movement of the autonomous vehicle using the determined status information.

8. The method of claim 1, the method further comprising in an autonomous vehicle control system of a second autonomous vehicle, controlling movement of the second autonomous vehicle using the determined status information.

9. The method of claim 1, wherein identifying the one or more entities disposed within the transportation hub using the perception data includes processing the perception data with a trained machine learning model disposed in a perception system of the autonomous vehicle.

10. The method of claim 9, wherein the trained machine learning model is a multi-head machine learning model including a plurality of output heads, the plurality of output heads including at least one entity identification output head that outputs the one or more entities disposed within the transportation hub and at least one mainline perception output head that outputs a plurality of objects detected in a vicinity of the autonomous vehicle.

11. The method of claim 1, wherein each of the one or more perception sensors includes an image sensor, a LIDAR sensor, or a RADAR sensor.

12. The method of claim 1, further comprising, in an autonomous vehicle control system of the autonomous vehicle or a different autonomous vehicle, controlling movement of the autonomous vehicle or the different autonomous vehicle to park the autonomous vehicle or the different autonomous vehicle in the available storage location or to drop off a freight carrier in an available storage location identified in the status information.

13. The method of claim 1, further comprising, in an autonomous vehicle control system of the autonomous vehicle or a different autonomous vehicle, controlling movement of the autonomous vehicle or the different autonomous vehicle for pickup of a freight carrier based upon a location of the freight carrier identified in the determined status information.

14. The method of claim 1, wherein the transportation hub is a trucking drop yard, a container port, an intermodal freight facility, or a loading dock.

15. The method of claim 1, wherein identifying the one or more entities includes identifying a freight carrier stored in the transportation hub, and determining the status information includes determining an identification and/or location of the freight carrier in the transportation hub.

16. The method of claim 1, wherein identifying the one or more entities includes identifying a vehicle parked in the transportation hub, and determining the status information includes determining an identification and/or location of the vehicle in the transportation hub.

17. The method of claim 1, wherein determining the status information includes identifying one or more available storage locations in the transportation hub.

18. The method of claim 17, wherein identifying the one or more entities includes identifying a plurality of vehicles and/or freight carriers in the transportation hub, the method further includes mapping the identified plurality of vehicles and/or freight carriers to predetermined storage locations in a map of the transportation hub, and identifying the one or more available storage locations in the transportation hub includes identifying the one or more available storage locations using the mapping of the identified plurality of vehicles and/or freight carriers to the predetermined storage locations in the map of the transportation hub.

19. The method of claim 1, wherein identifying the one or more entities includes identifying a plurality of vehicles queued to perform a predetermined activity in the transportation hub, and determining the status information includes determining a number of vehicles waiting to perform the predetermined activity and/or estimated wait to perform the predetermined activity using the identified plurality of vehicles.

20. The method of claim 1, wherein identifying the one or more entities includes identifying first and second entities in the transportation hub, and determining the status information includes determining an incident between the first and second entities.

21. The method of claim 20, wherein each of the first and second entities is a vehicle, a freight carrier, a stationary object in the transportation hub, or an individual.

22. The method of claim 1, wherein identifying the one or more entities includes identifying one or more individuals in the transportation hub, and determining the status information includes determining a status or activity of the one or more individuals.

23. The method of claim 1, wherein the status information is first status information, the perception data is first perception data, and the autonomous vehicle is a first autonomous vehicle, the method further comprising receiving second status information for the transportation hub, the second status information determined using a plurality of entities identified using perception data captured by perception sensors of a plurality of autonomous vehicles during operation of the plurality of autonomous vehicles proximate the transportation hub.

24. The method of claim 23, further comprising:
receiving second perception data captured by one or more perception sensors of a second autonomous vehicle of the plurality of autonomous vehicles during operation of the second autonomous vehicle proximate the transportation hub; and
identifying one or more entities disposed within the transportation hub using the second perception data;
wherein at least a portion of the second status information is determined using the one or more entities identified using the second perception data.

25. The method of claim 23, further comprising initiating updating of a live status map of the transportation hub using the status information.

26. The method of claim 25, further comprising sharing at least a portion of the live status map of the transportation hub with one or more autonomous vehicles in a fleet, with a shipper, with a carrier, and/or with a governmental authority.

27. The method of claim 25, further comprising:
generating a summary report using at least a portion of the live status map of the transportation hub; and
sharing the summary report with one or more autonomous vehicles in a fleet, with a shipper, with a carrier, and/or with a governmental authority.

28. The method of claim 23, further comprising, in response to a query issued to an API, generating a response including at least a portion of the live status map.

29. An autonomous vehicle control system resident in an autonomous vehicle, the autonomous vehicle control system comprising:
at least one processor; and
memory storing instructions that, when executed, cause the at least one processor to be operable to perform a method comprising:
receiving perception data captured by one or more perception sensors of the autonomous vehicle during operation of the autonomous vehicle proximate a transportation hub;
identifying one or more entities disposed within the transportation hub using the perception data; and
determining status information for the transportation hub using the one or more entities identified using the perception data.

30. A method implemented by one or more processors, the method comprising:
receiving status information for a transportation hub, the status information determined using a plurality of entities identified using perception data captured by perception sensors of a plurality of autonomous vehicles during operation of the plurality of autonomous vehicles proximate the transportation hub;
updating a live status map of the transportation hub using the received status information; and
in response to each of a plurality of queries, sharing at least a portion of the live status map with one or more requesters.

31. A system comprising:
at least one processor; and
memory storing instructions that, when executed, cause the at least one processor to be operable to perform a method comprising:
receiving status information for a transportation hub, the status information determined using a plurality of entities identified using perception data captured by perception sensors of a plurality of autonomous vehicles during operation of the plurality of autonomous vehicles proximate the transportation hub;
updating a live status map of the transportation hub using the received status information; and
in response to each of a plurality of queries, sharing at least a portion of the live status map with one or more requesters.
